(19) United States
(12) Patent Application Publication
(10) Pub. No.: US 2025/0224590 A1
(43) Pub. Date: Jul. 10, 2025

(54) Imaging Lighting Lenses

(71) Applicant: SUNEX, INC., CARLSBAD, CA (US)

(72) Inventors: ALEX NING, CARLSBAD, CA (US); JINGBO CAI, CARLSBAD, CA (US)

(21) Appl. No.: 19/091,118

(22) Filed: Mar. 26, 2025

Related U.S. Application Data
(63) Continuation-in-part of application No. 17/806,765, filed on Jun. 14, 2022, now abandoned.
(60) Provisional application No. 63/202,755, filed on Jun. 23, 2021.
(60) Provisional application No. 63/656,992, filed on Jun. 6, 2024.
(60) Provisional application No. 63/683,139, filed on Aug. 14, 2024.

(51) Int. Cl. G02B 9/62

(52) U.S. Cl. CPC G02B 9/62

(57) ABSTRACT

A lens system design for an imaging projection lens is described. The system enables selection of performance requirements of a high or low resolution lens system as described through a set of examples meeting a set of parametric equations. A low resolution imaging lenses has a field angle between 15 and 20 degrees and effective focal lengths (EFL) between 18 and 25. The high resolution lens systems have an EFL between 30 and 38 source and field angles between 10 and 12 degrees. The examples all use a 12.8 mm light source (Ah). The lens system is scaled to other size light sources using the parametric equation for EFL/Ah. The lens system comprises two positive powered lens groups. There are 3 lens elements in a first group and 1 to 3 lens element in a second group, the second group is nearest the light source.

### CROSS REFERENCE TO RELATED APPLICATIONS

This application is a continuation-in-part of application Ser. No. 17/806,765 filed Jun. 14, 2022 which claims priority to U.S. Provisional Application 63/202,755, filed Jun. 23, 2021. This application also claims priority to U.S. Provisional Application 63/656,992, filed Jun. 6, 2024, and to U.S. Provisional application 63/683,139 filed Aug. 14, 2024 all titled IMAGING LIGHTING LENSES including common inventors and currently pending.

### STATEMENT REGARDING FEDERALLY SPONSORED RESEARCH OR DEVELOPMENT

Not Applicable.

### BACKGROUND OF THE INVENTION

### Technical Field

The invention relates to projection lens systems used primarily for automotive headlights.

### Related Background Art

Optical elements or lenses for traditional lighting applications such as vehicle headlights, room lighting, street and traffic lamps are designed as efficient light collectors. Imaging performance of such lenses has been less important than efficiency. New LED array lighting applications require lenses having not only efficient light collection but also excellent imaging performance. New lighting systems are used, for example, in automotive headlights, known as adaptive driving beam (ADB) headlights, where they can provide brighter illumination of a section of the roadway and at the same time reduced glare for oncoming drivers. New light sources include upwards of a million individually controllable pixels. Headlights can now automatically adjust for curvature and contours of the road and can also provide messaging, directional instructions and more. Efficient light collection and projection implies that the lens must have very high numerical aperture or low F/#. A low F/#requirement present significant challenges from image quality point of view because most of the image aberrations are highly dependent on the F #. For example, spherical and coma aberrations are difficult to correct with a low F/#lens. In addition, the lens has to be designed to meet other requirements such as minimum stray light, good temperature stability and acceptable color fringes due to restriction of both visual and government regulations. Furthermore, the full horizontal field of view FOV for these applications is also considerable with a range from 20 degrees on the narrow side to 40 degrees on the wide side, the aberration change over the full field could also present itself as a challenge. An object of this invention is to provide lens designs capable of providing good imaging performance while meeting these constraints and at the same time collecting light efficiently from array light sources such as LED matrix and micro-LED array chips and having a F/# in the range of 0.55-0.8. There is a need for the lens set to be compact. There is a need for a lens design that prioritizes light collection efficiency and cost, and, there is a need for a lens design that enables high resolution imaging. High resolution meaning in this case the ability to accurately display an image from an LED matrix chip that includes multiple pixels onto a surface that may be 1 to 10 meters away. The designs must also be cost-effective to manufacture. Both European and United States have published regulations for the performance of ADB headlights. The regulations include testing in road conditions such as at speeds and on straight and curved roads and with front approaching vehicles and vehicles approached from the rear, with requirements for light intensity and limits on glare to other drivers. The regulations cover what should be lit and what should not be lit and the definition of “lit” in terms of lux. An intent of the regulation is to maximize visibility to a driver and minimize glare to other drivers. ADB headlights have been commercialized for more than 20 years. However, lens designs that meet the heretofore little used new imaging capabilities of the LED arrays that are now commonly available, while maintaining efficient operation at a near commodity cost mean that prior art lenses are not sufficient. There is a need for new lens systems that enable imaging capabilities of the ADB headlights and lighting systems that go beyond the current definition of ADB. Development also requires a lens system that is adaptable to new uses, such as higher resolution light source arrays as well as lower resolution light sources, or, new mechanical designs and lighting designs for a vehicles front end. There is a need for a lens design that applies to both low resolution imaging light sources and higher resolution imaging light sources. There is a need for such a lens element to be modified to meet target values for parameters as normally applied to optics design rather than waiting for testing only in a finished vehicle.

### BRIEF SUMMARY OF THE INVENTION

A lens system that includes 4,5 and 6 lens element designs for imaging lenses is described. All embodiments of the lens system meet pre-selected operating parameters such as low f-number (F/#) and effective focal length range, and, further can be selected and optimized for particular imaging properties either as lower resolution applications used for low beam, wider illumination and high beam, narrower illumination. The lower resolution applications have larger spot size and if an image is formed using selected pixels from the array source the image formed would be lower resolution than that formed using the higher resolution, longer focal length and smaller individual pixel images. The embodiment lenses of the invention are presented as several illustrative examples. The illustrative examples are not all inclusive. Other similar embodiments are possible within the constraints of the claims. In the following description, distinction between lens element and lens group is not absolute because a lens group could contain just one lens element and one lens element can be split into a number of weaker elements which function equivalently as the replaced single element. Generally, each disclosed example comprises a number of lens elements which are numerically labeled in increasing order from the left to the right with the left most being L1. These lenses logically form into groups which are labeled numerically in increasing order from the left to the right with the left most being G1. Each lens group comprises one or several lens elements. Each lens element has two surfaces. The object surface of an element is defined as the surface facing the object space (the side to be illuminated) of the lens assembly. The plane of image is defined as location of the LED light source array. In all drawings the object space is on the left side of the lens assembly. The image surface of an element is defined as the lens surface facing the image space (the LED source) of the lens assembly. In all drawings the image space and light source array is on the right side of the lens assembly. Element surfaces can be flat (plano), spherical or aspheric. For an aspheric surface the following equation is used to describe the surface profile:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

In this equation z is the surface sag at radial distance r from the optical axis. The k is the conic constant. The c is the curvature or inverse of the radius of curvature. The term αᵢ is the i^{th} polynomial coefficient. Please refer to various lens design publications or Zemax® software manual (www.Zemax.com, Zemax is a registered US trademark of Zemax, LLC) for detailed description of this equation. The effective focal length of the whole lens assembly designated by EFL is the numerical value as calculated by the Zemax software EFFL optimization operand. The effective focal length of an element designated by appending “EFL_” to the name of the element such as “EFL_L #” is the numerical value as calculated by the Zemax software EFLY optimization operand over the two surfaces bounding the lens element #.

The effective focal length of a lens group designated by appending “EFL_” to the name of the lens group such as “EFL_G #” is the numerical value as calculated by the Zemax software EFLY optimization operand over the starting and ending surfaces of the lens group.

To designate the desirable configuration of current invention, a numerical range of the ratio of the effective focal length of a lens group or a lens element to the effective focal length of the whole lens assembly is given. In addition, the ratio of the radius of the image surface of the last lens element to the effective focal length of the whole lens is also given as a range to identify the desirable configuration.

The source array is rectangular and has a horizontal size (Aₕ) of 12.8 mm in all illustrative examples. The lens system is scalable to other light source array sizes as reflected in the parametric equations. All the lens systems have a compact design with total track length of the lens systems divided by the horizontal array size (Aₕ) of less than or equal to 5.1. The lens systems are also designed for economical manufacturing with the minimum value of the absolute value of the radius of curvature for all lens elements (|Ri|)>=15 mm. All lens systems have an F/# of 0.8 or less and satisfy the parametric equations discussed below.

The embodiments are divided into lower resolution lenses and higher resolution lenses, both have the same basic structural designs. Each having their own set of parametric equations. Resolution is measured by techniques as are known in the art, such as field of view and spot size, line resolution, etc. Low resolution lens examples have an effective focal length (EFL) between 18 and 25 mm and the high resolution lens examples have an EFL between 30 and 38 mm, each for a source array with a horizontal size (Ah) of 12.8 mm. The lens system is scaled to other size source arrays according to equation (10) for low resolution lens systems and according to equation (20) for the high resolution lens systems. Example 1 of FIG. 1 is a lower resolution example. Example 2 is a high resolution example. Low resolution is selected here by equation (10) and the higher resolution is selected by parametric equation (20):

$$1.2 <= EFL / Ah <= 2 \qquad ( 10 )$$

$$2.2 <= EFL / Ah <= 3 \qquad ( 20 )$$

The parametric equations (10) and (20) would give an equivalent sorting as to other common measures of resolution as discussed above. The lower resolution group satisfy the parametric equations (1)-(10). The higher resolution group satisfy the parametric equations (11)-(20).

The Imaging lighting lenses are comprised, from object to image, of two lens groups: a first positive powered lens group G1, and a second positive powered group G2. Group 1 includes only three lens elements and an aperture stop, and, group 2 consists of 1, 2 or 3 lens elements.

Group 1 includes a first positive lens element, a second negative lens element and a third positive lens element.

Each of the lens elements can be produced with near equivalent performance by using two or more lens elements, in the lower resolution cases of Examples 4-7, group 1 description could be described as including four lens elements, L1, L2 and L3 and L3′ respectively and the second group includes L4, and, L5 and L6 in 5 and 6 lens examples. Group 1 positive lens element 3 is divided into two positive lens elements. In all other examples, Group 1 has 3 elements with powers from object to image of +−+ and Group 2, has positive power and includes 1-3 lens elements. Group 1 includes an aperture stop. In some embodiments lens element 2 and 3 of group 1 form a cemented doublet.

The parametric equations for the low resolution designs is divided into 3 sets: one set (1)-(3) for the first lens group (G1), one for the second and third lens group, if any, (4)-(6), and, one set for the overall lens system (7)-(10).

### Group 1 Parameters

$$1.5 <= EFL\_G1 / EFL <= 2. \qquad ( 1 )$$

$$2.5 <= EFL\_L1 / EFL <= 3.5 \qquad ( 2 )$$

$$- 12. <= EFL\_L2 / EFL <= - 0.5 \qquad ( 3 )$$

$$0.9 <= EFL\_L3 / EFL <= 3.5 \qquad ( 4 )$$

### Group 2 Parameters

$$1. <= EFL\_G2 / EFL < = 1.6 \qquad ( 5 )$$

$$1.5 <= RL / EFL \qquad ( 6 )$$

### Overall Lens System Parameters

$$TTL / Ah < 5. \qquad ( 7 )$$

$$\vert Ri \vert / TTL > 0.23 \qquad ( 8 )$$

$$F / \# < 0.8 \qquad ( 9 )$$

$$1.2 <= EFL / Ah <= 2 \qquad ( 10 )$$

Where EFL_G1 means the effective focal length of the first lens group, EFL is the effective focal length of the entire lens system, EFL_L1 is the effective focal length of the first lens element in group 1 and EFL_L2 is the effective focal length of the second lens, and so on. The image surface of the last element facing the light source array has a curvature radius of RL. The compact design of the lens system is reflected in equation 7 where the total track length divided by the horizontal dimension of the light source (TTL/Ah) is less than 5.0. In the examples shown the TTL is less than 58 mm for the low resolution set and less than 78 mm for the higher resolution set. One aspect of ease of manufacturing is reflected in part in equation 8 where the absolute value of the radius of curvature for any single lens element (|Ri|) divided by the total track length (TTL) is greater than 0.23. All of the designs are optically efficient with a low f/#reflected in equation 9. Equations (10) and (20), Effective focal length for the whole lens system divided by the horizontal size of the light source array (EFL/Ah) are a parametric definition for low resolution and high resolution lens systems respectively.

The higher resolution embodiments all have higher resolution capabilities relative to those designs described above as low resolution. Resolution is measured by techniques as are known in the art, such as spot size, line resolution, etc. The higher resolution lens systems have a field angle between +/−10 and 12 degrees and an EFL between 30 mm and 38 mm for a 12.8 mm sized array (Ah). The higher resolution set are comprised, from object to image, of two lens groups: a first positive powered lens group G1, having three lens elements of positive, negative and positive powers in that order from object to image, and a second positive powered lens group G2 having 1, 2 or 3 lens elements, with lens elements having powers of +OR+−OR+−+ for 1, 2 or 3 lens elements respectively. High resolution embodiments satisfy the parametric equations (11)-(20). The parametric equations for high resolution designs are divided into 3 sets: one set for each of the lens groups, G1 and G2, and, one set for the overall lens system (16)-(20). The lens elements of groups G1 and G2 have powers that are positive, negative, positive, for L1, L2 and L3 in Group 1 and Group 4 lens elements combined have positive power.

### Group 1 Parameters

$$1.6 <= EFL\_G1 / EFL <= 2.4 \qquad ( 11 )$$

$$1.5 <= EFL\_L1 / EFL <= 4. \qquad ( 12 )$$

$$- 4. <= EFL\_L2 / EFL <= - 1. \qquad ( 13 )$$

$$1. <= EFL\_L3 / EFL <= 3. \qquad ( 14 )$$

### Group 2 Parameters

$$1. <= EFL\_G2 / EFL <= 4.5 \qquad ( 15 )$$

$$0.3 <= {R}_{L} / EFL \qquad ( 16 )$$

### Overall Lens System Parameters

$$TTL / {A}_{h} < 6. \qquad ( 17 )$$

$$\vert {R}_{i} \vert / TTL >= 0.16 \qquad ( 18 )$$

$$F / \# < 0.8 \qquad ( 19 )$$

$$2.2 <= EFL / {A}_{h} <= 3. \qquad ( 20 )$$

Where the symbol definitions are the same as for the lower resolution group discussed above. The EFL for other size arrays scales according to Equation (20). For example, a lens system design with an EFL of 30 mm, a 12.8 mm array (Ah), and, EFL/Ah=30/12.8=2.3 would have an EFL of 31.4 for use with a 13.4 mm wide source array. High resolution embodiments are described in detail through a set of examples 2, and, 8-27 below. The lens embodiments are all part of a lens system that can be modified, as shown through examples, to meet pre-selected targets for lens performance values such as EFL.

The embodiments are sorted into low resolution and high resolution examples in the order of 4, 5 and 6 lens element examples, corresponding to 1, 2 or 3 lens elements in Group 4 and three lens elements in group 1, where group 2 is nearest the imaging light source.

### BRIEF DESCRIPTION OF THE DRAWINGS

FIG. 1A shows a cross-section schematic view of a lower resolution example.

FIG. 1B shows a schematic view of an example LED array light source that is used with all of the examples.

FIG. 2 show cross-section schematic views of high resolution example.

FIG. 3-7 shows cross-section schematic views of four and five lens element lower resolution examples.

FIG. 3 shows a cross-section schematic view of a low resolution four lens example.

FIG. 4 shows a cross-section schematic view of a low resolution five lens example.

FIG. 5 shows a cross-section schematic view of a low resolution five lens example.

FIG. 6 shows a cross-section schematic view of a low resolution five lens example.

FIG. 7 shows a cross-section schematic view of a low resolution five lens example.

FIGS. 8-26 show four, five and six lens element examples of higher resolution examples.

FIG. 8 shows a cross-section schematic view of a higher resolution four lens example.

FIG. 9 shows a cross-section schematic view of a higher resolution four lens example.

FIG. 10 shows a cross-section schematic view of a higher resolution four lens example.

FIG. 11 shows a cross-section schematic view of a higher resolution four lens example.

FIG. 12 shows a cross-section schematic view of a higher resolution four lens example.

FIG. 13 shows a cross-section schematic view of a higher resolution five lens example.

FIG. 14 shows a cross-section schematic view of a higher resolution five lens example.

FIG. 15 shows a cross-section schematic view of a higher resolution five lens example.

FIG. 16 shows a cross-section schematic view of a higher resolution six lens example.

FIG. 17 shows a cross-section schematic view of a higher resolution six lens example.

FIG. 18 shows a cross-section schematic view of a higher resolution six lens example.

FIG. 19 shows a cross-section schematic view of a higher resolution six lens example.

FIG. 20 shows a cross-section schematic view of a higher resolution six lens example.

FIG. 21 shows a cross-section schematic view of a higher resolution six lens example.

FIG. 22 shows a cross-section schematic view of a higher resolution six lens example.

FIG. 23 shows a cross-section schematic view of a higher resolution six lens example.

FIG. 24 shows a cross-section schematic view of a higher resolution six lens example.

FIG. 25 shows a cross-section schematic view of a higher resolution six lens example.

FIG. 26 shows a cross-section schematic view of a higher resolution six lens example.

FIG. 27 shows a cross-section schematic view of a higher resolution five lens example.

### DETAILED DESCRIPTION OF THE INVENTION

The invented lens systems are divided into high resolution examples and lower resolution examples. The lower resolution examples satisfy parametric equations (1)-(10) and the higher resolution examples satisfy parametric equations (11)-(20). All of the reported lens systems meet criteria for high optical efficiency, F-number (F/#) less than 0.8 as in parametric equation (9) and (19), compact size, Total track length (TTL)/Ah<5.1 as in parametric equations (7) and (17) and design for manufacturability through constraints on individual lens elements' radii of curvature as in parametric equations (8) and (18).

All embodiments are comprised of two lens groups. In order from object to image, the first group has positive power and is comprised of three lens elements with positive, negative positive optical powers. In some embodiments, shown in examples 4-7 the third positive lens element of Group 1 is split into two positive lens elements making a low resolution five lens element embodiment. The second lens group has positive power and comprises one, two or three lens elements. The group 2 lens element in the case of one lens element in group 2 has positive power. The lens elements in the case of two lens elements in group two have positive and negative powers and the case of three lens elements in group 2 have positive, positive, negative optical powers.

In a preferred embodiment the lens system consists only of the three lens elements in Group 1 and consists only of one, two, or, three lens elements in group 2 each with the optical powers as described in the order as described above.

### Example 1

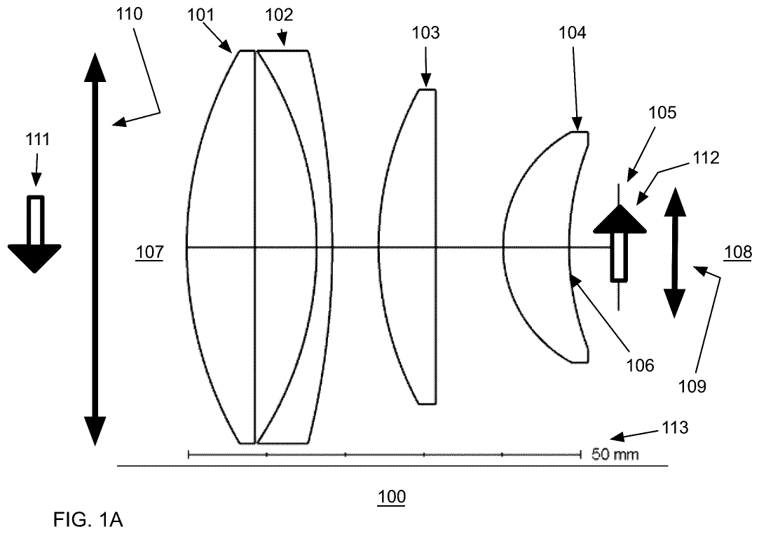

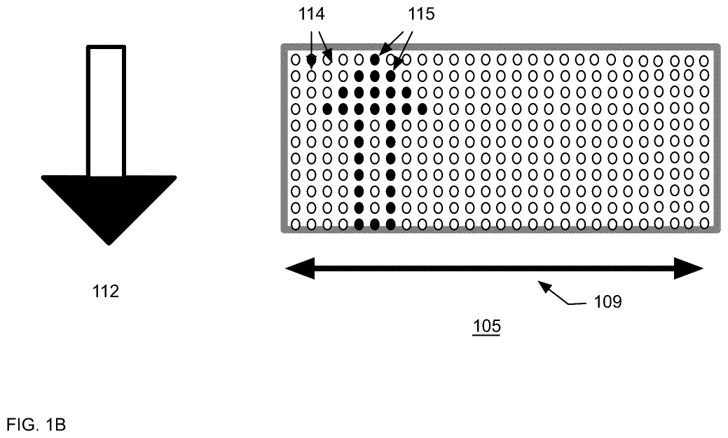

FIG. 1A shows the layout of a first lens system 100. This design has a field angle of +/−15° with a relative aperture (F/#) of F/0.58 and an effective focal length EFL of 24.5 mm with a 12.8 mm source. The same lens design scales to other size sources through equation (10). The 1^{st} example of present invention shows an imaging lighting lens of a very low F/#which has very good optical efficiency and is a lower resolution example.

It comprises two lens groups, in order from object end 107 to the light source end 108. A first positive power group (counting from the object side) comprises three elements L1 101, L2 102, and L3, 103 with positive, negative and positive powers respectively. The effective focal length of the 1^{st} group is EFL_G1 and the effective focal length of L1 101 is EFL_L1, L2 102 is EFL_L2, and the effective focal length of the third lens element in group 1 is EFL_L3. A second positive power group comprises one to three lens elements with positive optical power in the case of a single lens element, positive then negative power with two lens elements and positive, positive, negative optical powers in the case of three lens elements. In this case a single lens element 104. The effective focal length of the 2^{nd} group and single lens 104 in the second group is EFL_L4 and also EFL_G2.

The image surface (RL) 106 of the last element is concave facing the light source array 105 and has a curvature radius divided by the total track length (TTL) satisfying Equation (6).

In a preferred embodiment all lens elements are made of glass material in order to achieve maximum thermal stability. Further the curvature of individual lens shape is chosen to lower fabrication cost, stray light minimization and aberration contribution. All of the lens elements in this first example are spherical. The radius of curvature for all surfaces of all lens elements divided by the total track length: |Rᵢ|/TTL>=0.23 as in equation (8).

The lens has a compact design. The clear diameter 110 of the lens system is 50 mm. The physical length (TTL) 113 of the lens system is 65 mm. The lens system is used to project an image or light pattern 111 originating from an image or light pattern 112 formed on the light source 105. A non-limiting example light source is an LED array 105 having a horizontal size (Aₕ) 109 of 12.8 mm. Details of an example LED array light source are shown in FIG. 1B. The dimensions of the lens system 100 are scaled to accommodate light sources 105 having different dimensions.

Table 1 shows the optical prescription of Example 1.

TABLE 1

| | | Radius | Thickness | | Clear | |
|---|---|---|---|---|---|---|
| Surface | Type | (mm) | (mm) | nd, abbe number | Diame [symbol] | lens |
| OBJ | SPHERICAL | Infinity | Infinity | | 0.00 | |
| 1 | SPHERICAL | 49.69 | 8.70 | 1.772, 49.613 | 50.00 | L1 |
| STO | SPHERICAL | Infinity | 7.87 | | 50.00 | |
| 3 | SPHERICAL | −44.82 | 2.00 | 1.846, 23.787 | 50.00 | L2 |
| 4 | SPHERICAL | −102.40 | 5.90 | | 50.00 | |
| 5 | SPHERICAL | 41.61 | 7.30 | 1.773, 49.614 | 40.00 | L3 |
| 6 | SPHERICAL | Infinity | 8.56 | | 39.00 | |
| 7 | SPHERICAL | 16.71 | 8.41 | 1.903, 31.318 | 29.00 | L4 |
| 8 | SPHERICAL | 35.84 | 6.30 | | 26.00 | |
| IMA | SPHERICAL | Infinity | | | 15.50 | |

[symbol]

indicates data missing or illegible when filed

The conditional expressions of Equations (1)-(10) are satisfied:

| Parameter | Value |
|---|---|
| EFL | 24.5 |
| F-number | 0.58 |
| EFL_G1/EFL | 1.925 |
| EFL_L1/EFL | 2.611 |
| EFL_L2/EFL | −3.869 |
| EFL_L3 | 2.187 |
| EFL_G2/EFL | 1.161 |
| EFL_L4 | 1.161 |
| EFL/Ah | 1.9 |
| RL/EFL | 1.46 |
| TTL/Ah | 4.30 |
| R7/TTL | 0.30 |
| EFL/Ah | 1.91 |

Where R7 is the smallest radius of curvature for all lens elements Ri.

FIG. 1B shows some details of the light source 105. The light source is comprised of an array of LEDs 114, 115 that are individually controlled to form an image 112. In the example shown the image 112 is an upward facing arrow and a portion of the LEDs 114 are lit or “ON” and a second portion of the LEDs 115 are dark or OFF where the pattern of the on and off LEDs form the image of an arrow 112. The image 112 may also be formed by reversing the ON/OFF state of the individual LEDs 114, 115. The horizontal width Ah 109 in the examples is 12.8 mm, but, the imaging lens design may be scaled according to the parametric equations (10) for low resolution designs and equation (20) for the high resolution designs to accommodate other size (Ah) light sources.

### Example 2

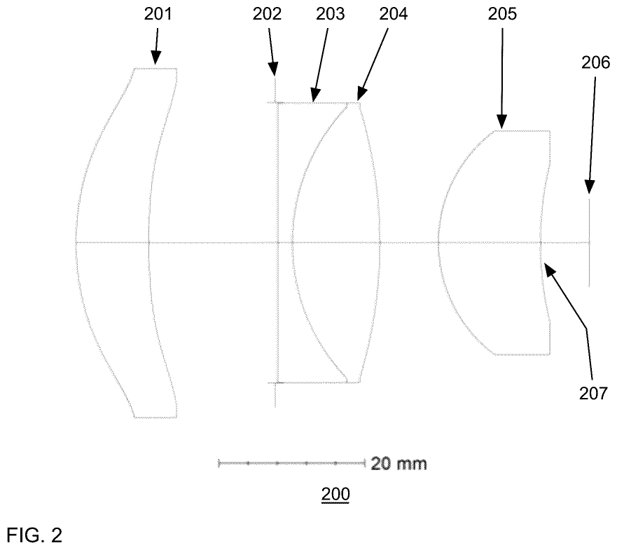

FIG. 2 shows the layout of a higher resolution embodiment of an imaging projection lens system 200. This design has a field angle of +/−12° with a relative aperture of F/0.68 and an effective focal length EFL of 29.5 mm when used with a 12.8 mm (Ah) image source. The design is scaled to other size sources using Equation (20). The 2^{nd} example shows an imaging lighting lens which has both good optical efficiency and is high resolution.

It comprises two lens groups. A first group (G1, counting from the object, left, side) comprises an aspheric element L1 201, where at least one of the two lens surfaces is aspheric, a negative power element L2, 202 and a positive power element L3, 204. L2 and L3 form an air spaced doublet or cemented doublet. The first group includes aperture stop 202 near the object surface of L2. The first group's effective focal length is EFL_G1. A second group G2, with an effective focal length EFL_G2, comprises positive power element L4 205. The last surface 207 of the group G4, nearest the light source 206 is concave and has a radius of curvature R_{L}.

In preferred embodiment, the EFL_G1 should be equal or greater than 2 times the EFL of the whole lens in order to achieve maximum thermal stability. The stop aperture 202 is optimally located at or close to the doublet in the 2^{nd} group to achieve good chromatic aberration correction which is important for visual and regulation requirements. Further the radius of curvature of all lens shapes is chosen to lower fabrication cost, stray light generation and aberration contribution as indicated by parametric equation (18).

Table 2 shows the optical prescription of Example 2.

TABLE 2

| | | | | | Clear | lens |
|---|---|---|---|---|---|---|
| Surface | Type | Radius | Thickness | ND, ABBE NO. | Diam [symbol] | elemen [symbol] |
| OBJ | SPHERICAL | Infinity | Infinity | | 0.00 | |
| 1 | ASPHERICAL | 36.44 | 10.00 | 1.493, 53.961 | 47.79 | L1 |
| 2 | ASPHERICAL | 99.24 | 17.30 | | 45.34 | |
| STO | SPHERICAL | Infinity | 0.37 | | 38.33 | |
| 4 | SPHERICAL | −3858.00 | 2.00 | 1.672, 32.178 | 38.26 | L2 |
| 5 | SPHERICAL | 26.89 | 12.00 | 1.696, 55.534 | 37.03 | L3 |
| 6 | SPHERICAL | −63.11 | 7.98 | | 37.03 | |
| 7 | SPHERICAL | 19.00 | 14.00 | 1.729, 54.669 | 30.59 | L4 |
| 8 | SPHERICAL | 45.75 | 6.76 | | 21.79 | |
| IMA | SPHERICAL | Infinity | | | 12.23 | |

[symbol]

indicates data missing or illegible when filed

L1 object and image surfaces are aspherical described by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

The parameters for this equation are as follows:

### Object Surface of L1

| | |
|---|---|
| Coefficient on r² | 0 |
| Coefficient on r⁴ | 8.88E−06 |
| Coefficient on r⁶ | −8.29E−09 |
| Coefficient on r⁸ | −2.14E−11 |

### Image Surface of L1

| | |
|---|---|
| Coefficient on r² | 0 |
| Coefficient on r⁴ | 2.16E−05 |
| Coefficient on r⁶ | −3.75E−08 |
| Coefficient on r⁸ | 8.93E−12 |

The parametric expressions of equations (11)-(20) are satisfied:

| Parameter | Value |
|---|---|
| EFL | 29.50 |
| F-number | 0.68 |
| EFL_G1/EFL | 1.997 |
| EFL_L1/EFL | 3.75 |
| EFL_L2/EFL | −1.34 |
| EFL_L3/EFL | 0.97 |
| EFL_G2/EFL | 1.23 |
| EFL_L4/EFL | 1.23 |
| R_{L}/EFL | 1.55 |
| TTL/Ah | 5.5 |
| R7/TTL | 0.27 |
| EFL/Ah | 2.30 |

The minimum radius of curvature of all lens surfaces |Ri|, is |R7|. The powers of groups G1, and, G2 are positive and the powers of lens elements L1, −L4 are positive, negative, positive, positive (+−++) respectively.

### Example 3

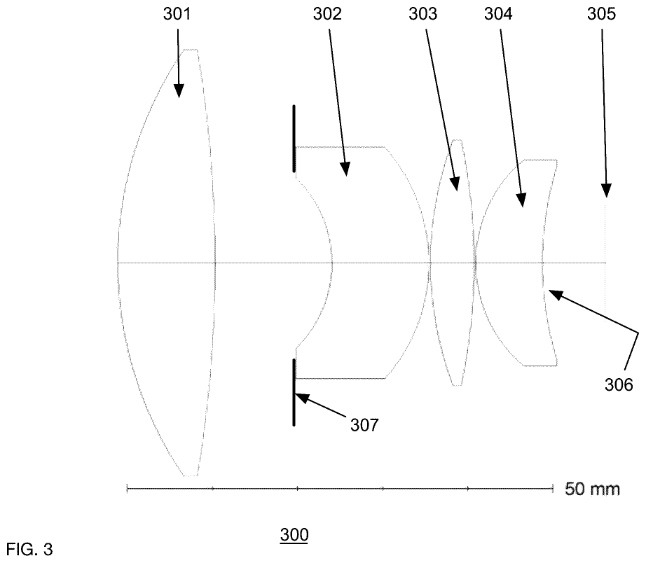

FIG. 3 shows the layout of a second example of a lower resolution four lens element imaging projection lens system 300. The example satisfies parametric equations (1)-(10). This design has a field angle of +/−20° with a relative aperture of F/0.70 and an effective focal length of 18.4 mm. The example of present invention shows an imaging lighting lens of a low F/#which has good optical efficiency and less requirement in resolution.

This example, as for all other examples, comprises two lens groups. Group 1 has positive power and comprises three lens elements. L1, 301, L2, 302, and, L3 303. The powers of the lens elements in group 1 are positive, negative, positive, respectively. An aperture stop 307 is located in group 1 near the object surface of L2, 302. Group 2, in this example, includes a single, positive power lens element 304. The image side surface 306 is concave and has a curvature satisfying parametric equation (6). All of the lens surfaces are spherical and all lens elements are made of glass. The optical prescription for example 3 is shown in Table 3.

TABLE 3

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | 10000.00 | | | |
| 1 | SPHERICAL | 43.92 | 11.43 | 1.568, 56.059 | 50.00 | L1 |
| 2 | SPHERICAL | −150.32 | 13.72 | | 50.00 | |
| STO | SPHERICAL | −13.92 | 11.39 | 1.620, 60.373 | 19.96 | L2 |
| 4 | SPHERICAL | −20.43 | 0.20 | | 27.05 | |
| 5 | SPHERICAL | 40.36 | 5.13 | 1.620, 60.373 | 28.85 | L3 |
| 6 | SPHERICAL | −68.50 | 0.18 | | 28.79 | |
| 7 | SPHERICAL | 15.67 | 7.83 | 1.772, 49.613 | 24.10 | L4 |
| 8 | SPHERICAL | 38.17 | 7.49 | | 22.71 | |
| IMA | SPHERICAL | Infinity | | | 14.17 | |

[symbol]

indicates data missing or illegible when filed

The parametric equations (1)-(10) are satisfied:

| | |
|---|---|
| EFL | 18.4 |
| F-number | 0.7 |
| EFL_G1/EFL | 1.928 |
| EFL_L1/EFL | 3.3 |
| EFL_L2/EFL | −11.55 |
| EFL_L3/EFL | 2.254 |
| EFL_G2/EFL | 1.614 |
| EFL_L4/EFL | 1.614 |
| TTL/Ah | 4.48 |
| RL/EFL | 2.07 |
| R7/EFL | 0.27 |
| EFL/Ah | 1.44 |

Examples 4-7 show a lower resolution imaging in which the last lens element in the first group is split into two lens elements L3_1 and L3_2.

### Example 4

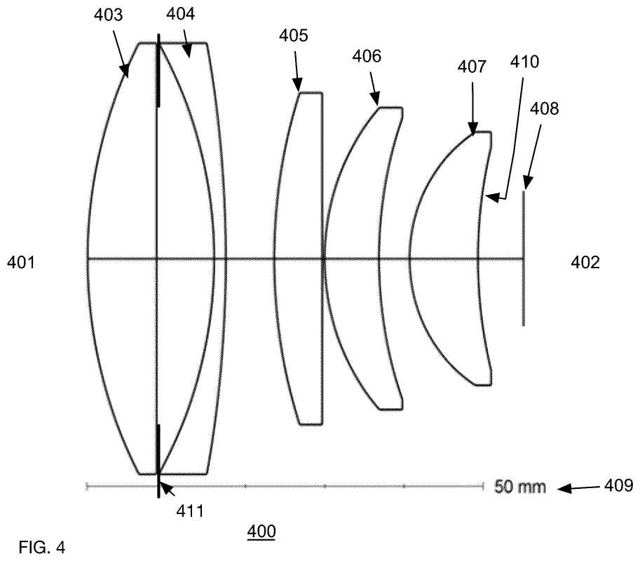

FIG. 4 shows the layout of a low resolution five lens element embodiment lens system 400. This design has a field angle of +/−15° with a relative aperture of F/0.64 and an effective focal length EFL of 24.8 mm. This example of the present invention shows an imaging lighting lens of a very low F/#which has very good optical efficiency but less requirement in resolution.

It comprises 2 lens groups. Group 1 comprises from object 401 to image light source end 402, L1 403, L2 404 and L3_1 405 and L3_2. In this example the positive lens element L3 is split into two positive lens elements L3_1 and L3_2. Group 1 has an effective focal length of EFL_G1. L1, L2 and L3 (L3_1 and L3_2) have positive, negative and positive optical powers respectfully. An aperture stop 411 is located on the image surface of L1 403. Group 2 comprises two positive power lens elements, L4 406 and L5 407. Group 2 has an effective focal length of EFL_G2 and positive power. The image surface 410 of the Group 2 last element has a radius of R_{L}. In a preferred embodiment all lens elements are made of glass material in order to achieve maximum thermal stability. Further the bending of individual lens shape is chosen to lower fabrication cost, stray light generation and aberration contribution. The radius of curvature for all surfaces of all lens elements divided by the total track length |Rᵢ|/TTL>=0.23.

Table 4 shows the optical prescription of Example 4.

TABLE 4

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | Infinity | | 0.00 | |
| 1 | SPHERICAL | 51.61 | 8.70 | 1.772, 49.613 | 50.00 | L1 |
| STO | SPHERICAL | Infinity | 7.25 | | 38.12 | |
| 3 | SPHERICAL | −48.19 | 1.49 | 1.846, 23.787 | 50.00 | L2 |
| 4 | SPHERICAL | −131.33 | 6.10 | | 50.00 | |
| 5 | SPHERICAL | 59.44 | 6.06 | 1.772, 49.613 | 38.50 | L3 |
| 6 | SPHERICAL | Infinity | 0.30 | | 37.81 | |
| 7 | SPHERICAL | 25.65 | 6.86 | 1.622, 58.154 | 35.04 | L4 |
| 8 | SPHERICAL | 46.52 | 3.87 | | 32.63 | |
| 9 | SPHERICAL | 17.15 | 8.65 | 1.622, 58.154 | 29.39 | L5 |
| 10 | SPHERICAL | 52.05 | 5.76 | | 25.98 | |
| IMA | SPHERICAL | Infinity | | | 15.73 | |

[symbol]

indicates data missing or illegible when filed

Parametric expressions (1)-(10) are satisfied:

| | |
|---|---|
| EFL | 24.8 |
| f-number | 0.64 |
| EFL_G1/EFL | 1.56 |
| EFL_L1/EFL | 2.68 |
| EFL_L2/EFL | −3.63 |
| EFL_L3_1/EFL | 3.09 |
| EFL_L3_2/EFL | 3.28 |
| EFL_G2/EFL | 1.50 |
| EFL_L4/EFL | 1.51 |
| R_{L}/EFL | 2.10 |
| R9/EFL | 0.31 |
| TTL/Ah | 4.30 |
| EFL/Ah | 1.94 |

Where R9 is the smallest radius of curvature for all lens element surfaces Ri.

### Example 5

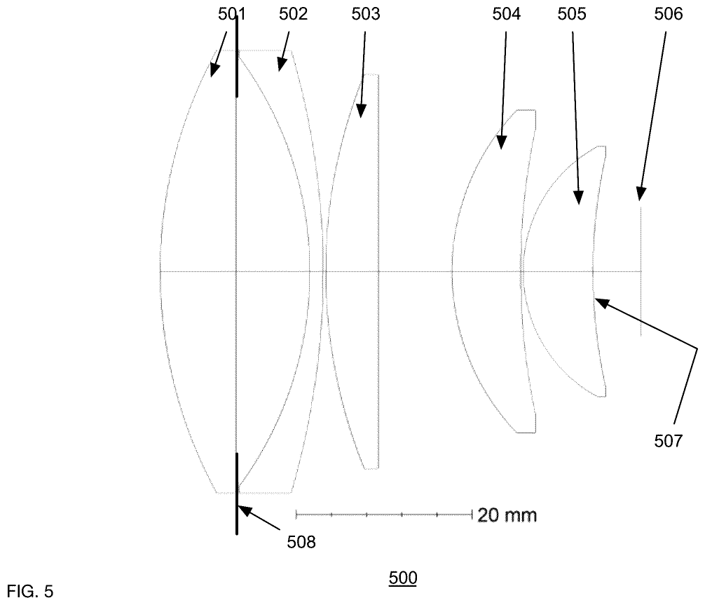

FIG. 5 shows the layout of a second low resolution embodiment lens system 500 that has four lens elements in the first group where the third lens element L3, is split into two lens elements L3_1 and L3_2. The second group has a single positive lens element or five lens elements total. This design has a field angle of +/−15° with a relative aperture of F/0.6 and an effective focal length of 24.4 mm. The 5^{th} example of present invention shows an imaging lighting lens of a very low F/#which has very good optical efficiency but less requirement in resolution. It comprises 2 lens groups. Group 1 comprises L1 501, L2 502. and L3_1 503 and L3_2 504. Group 1 has an effective focal length of EFL_G1. L1, L2 and L3 (L3_1 and L3_2) have positive, negative and positive optical powers respectively. There is an aperture stop 508 on the image side of lens L1. Group 2 comprises L4 505. Group 2 has an effective focal length of EFL_G2. L4 has positive power with an effective focal length of EFL_L4. The image surface 507 of the Group 2 last element, nearest the light source 506 has a radius of R_{L}. In a preferred embodiment all lens elements are made of glass material in order to achieve maximum thermal stability. Further the bending of individual lens shape is chosen to lower fabrication cost, stray light generation and aberration contribution. Table 5 shows the optical prescription of Example 5.

TABLE 5

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | Infinity | | | |
| 1 | SPHERICAL | 52.11 | 8.59 | 1.772, 49.613 | 50.00 | L1 |
| STO | SPHERICAL | Infinity | 8.39 | | 40.52 | |
| 3 | SPHERICAL | −40.68 | 1.51 | 1.846, 23.787 | 48.62 | L2 |
| 4 | SPHERICAL | −88.33 | 0.29 | | 50.00 | |
| 5 | SPHERICAL | 58.92 | 5.96 | 1.772, 49.613 | 44.57 | L3 |
| 6 | SPHERICAL | Infinity | 8.38 | | 44.57 | |
| 7 | SPHERICAL | 26.25 | 7.80 | 1.589, 61.267 | 36.47 | L4 |
| 8 | SPHERICAL | 77.44 | 0.30 | | 32.42 | |
| 9 | SPHERICAL | 16.09 | 7.91 | 1.589, 61.267 | 28.36 | L5 |
| 10 | SPHERICAL | 59.60 | 5.47 | | 26.34 | |
| IMA | SPHERICAL | Infinity | | | 14.66 | |

[symbol]

indicates data missing or illegible when filed

The parametric equations (1)-(10) are satisfied:

| | |
|---|---|
| EFL | 24.4 |
| F-NUMBER | 0.6 |
| EFL_G1/EFL | 1.539 |
| EFL_L1/EFL | 2.751 |
| EFL_L2/EFL | −3.672 |
| EFL_L3_1/EFL | 3.11 |
| EFL_L3_2/EFL | 2.604 |
| EFL_G2/EFL | 1.43 |
| EFL_L4/EFL | 1.43 |
| R_{L}/EFL | 2.44 |
| TTL/Ah | 4.27 |
| R9/EFL | 0.29 |
| EFL/Ah | 1.91 |

Where R9 is the smallest radius of curvature for all lens element surfaces Ri.

### Example 6

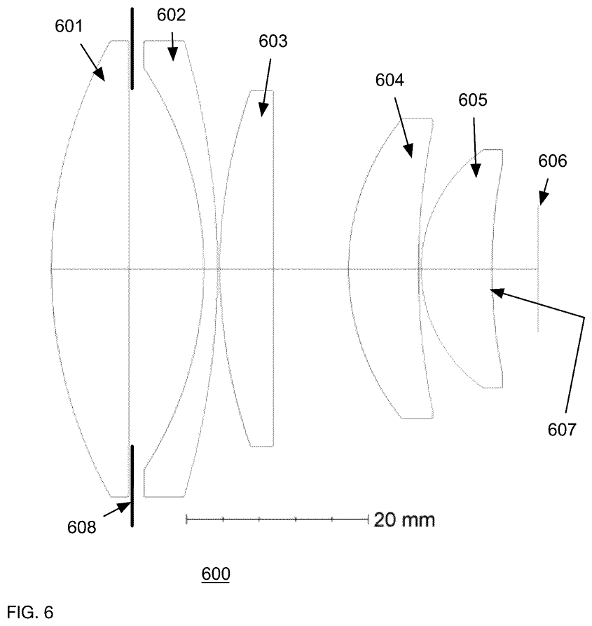

FIG. 6 shows the layout of a third lower resolution embodiment 600 in which the third lens element of group 1 is split into two lens elements two lens elements in and Group 2 has a single lens element, or, five lens elements total. This design has a field angle of +/−15° with a relative aperture of F/0.6 and an effective focal length of 23.3 mm. The example shows an imaging lighting lens 600 of a very low F/#which has very good optical efficiency but less requirement in resolution.

It comprises 2 lens groups. Group 1 comprises L1 601, L2 602 and L3_1 603 and L3_2 604. There is an aperture stop located on the image surface of L1. Group 1 has an effective focal length of EFL_G1. L1, L2 and L3, comprising L3_1 and L3_2, have positive, negative positive optical powers respectively. Group 2 comprises L4 605. Group 2 has an effective focal length of EFL_G2 comprising the single lens element, L4 of positive power with an effective focal length of EFL_L4. The image surface of the Group 2 last element has a radius of R_{L}. In a preferred embodiment all lens elements are made of glass material in order to achieve maximum thermal stability. Further the bending of individual lens shape is chosen to lower fabrication cost, stray light generation and aberration contribution.

Table 6 shows the optical prescription of Example 6.

TABLE 6

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | Infinity | | 0.00 | |
| 1 | SPHERICAL | 51.44 | 8.48 | 1.772, 49.613 | 50.00 | L1 |
| STO | SPHERICAL | Infinity | 8.29 | | 38.60 | |
| 3 | SPHERICAL | −40.16 | 1.49 | 1.846, 23.787 | 44.00 | L2 |
| 4 | SPHERICAL | −87.19 | 0.29 | | 50.00 | |
| 5 | SPHERICAL | 58.17 | 5.88 | 1.772, 49.613 | 39.00 | L3 |
| 6 | SPHERICAL | Infinity | 8.27 | | 39.00 | |
| 7 | SPHERICAL | 25.92 | 7.70 | 1.622, 58.154 | 32.90 | L4 |
| 8 | SPHERICAL | 76.45 | 0.30 | | 30.65 | |
| 9 | SPHERICAL | 15.88 | 7.81 | 1.622, 58.154 | 26.09 | L5 |
| 10 | SPHERICAL | 58.84 | 5.01 | | 23.06 | |
| IMA | SPHERICAL | Infinity | | | 14.12 | |

[symbol]

indicates data missing or illegible when filed

The parametric equations (1)-(10) are satisfied.

| | |
|---|---|
| EFL | 23.3 |
| F-NUMBER | 0.6 |
| EFL_G1/EFL | 1.558 |
| EFL_L1/EFL | 2.847 |
| EFL_L2/EFL | −3.8 |
| EFL_L3_1/EFL | 3.219 |
| EFL_L3_2/EFL | 2.543 |
| EFL_G2/EFL | 1.396 |
| EFL_L4/EFL | 1.396 |
| R_{L}/EFL | 2.53 |
| R9/TTL | 0.30 |
| TTL/Ah | 4.18 |
| EFL/Ah | 1.82 |

Where R9 is the smallest radius of curvature for all lens element surfaces Ri.

### Example 7

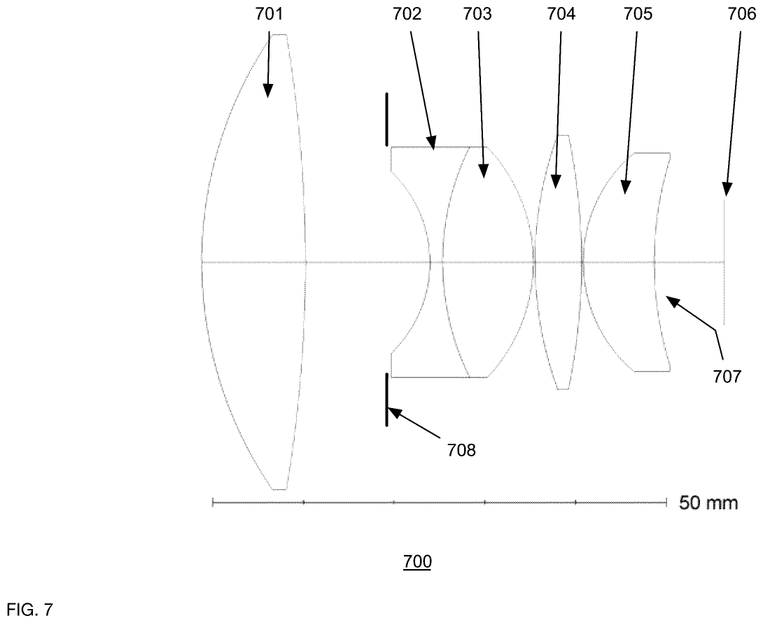

FIG. 7 shows the layout of a low resolution embodiment of an imaging projection lens system 700 where the third lens element in Group 1 is split into two lens elements L3_1 and L3_2. This design has a field angle of +/−20° with a relative aperture of F/0.70 and an effective focal length of 18.4 mm. This example of present invention shows an imaging lighting lens of a low F/#which has good optical efficiency and less requirement in resolution.

It comprises two lens groups. Group 1 comprises L1 701, L2 702 and L3_1 703 and L3_2 704, and has an effective focal length of EFL_G1. L2 and L3_1 form a cemented doublet or air gap doublet. The cemented surface is helpful in the reduction of blue fringes. An aperture stop 708 is located in group 1 at the object surface of L2. The optical powers of the lens elements in the first group are positive, negative, positive respectively. Group 2 comprises of the single Positive power lens element lens elements L4 705 and has an effective focal length of EFL_G2. The image surface 707 of the last element nearest the light source 706 has a radius of RL. In a preferred embodiment all lens elements are made of glass material in order to achieve maximum thermal stability. Further the bending of individual lens shape is chosen to lower fabrication cost, stray light generation and aberration contribution. Table 7 shows the optical prescription of Example 7.

TABLE 7

| | | | | ND, ABBE | Clear | |
|---|---|---|---|---|---|---|
| Surf | Type | Radius | Thickness | NUMBER | Diam [symbol] | LENS |
| OBJ | SPHERICAL | Infinity | 10000 | | | |
| 1 | SPHERICAL | 43.91 | 11.43 | 1.568, 56.059 | 50.00 | L1 |
| 2 | SPHERICAL | −150.32 | 13.72 | | 50.00 | |
| STO | SPHERICAL | −13.85 | 1.40 | 1.620, 36.347 | 19.98 | L2 |
| 4 | SPHERICAL | 28.31 | 9.99 | 1.568, 56.059 | 25.33 | L3 |
| 5 | SPHERICAL | −18.47 | 0.20 | | 25.33 | |
| 6 | SPHERICAL | 40.36 | 5.13 | 1.622, 58.154 | 27.97 | L4 |
| 7 | SPHERICAL | −68.50 | 0.18 | | 27.80 | |
| 8 | SPHERICAL | 15.67 | 7.83 | 1.772, 49.613 | 24.10 | L5 |
| 9 | SPHERICAL | 38.17 | 7.68 | | 22.71 | |
| IMA | SPHERICAL | Infinity | | | 13.95 | |

[symbol]

indicates data missing or illegible when filed

The parametric equations (1)-(10) are satisfied.

| | |
|---|---|
| EFL | 18.4 |
| F-NUMBER | 0.7 |
| EFL_G1/EFL | 1.956 |
| EFL_L1/EFL | 3.30 |
| EFL_L2/EFL | −0.801 |
| EFL_L3_1/EFL | 1.154 |
| EFL_L3_2/EFL | 2.249 |
| EFL_G2/EFL | 1.617 |
| EFL_L4/EFL | 1.617 |
| R_{L}/EFL | 2.07 |
| R3/EFL | 0.24 |
| TTL/Ah | 4.50 |
| EFL/Ah | 1.44 |

Where R3 has the smallest radius of curvature of all lens element surfaces.

### Higher Resolution Examples

Examples 8-26 represent higher resolution embodiments satisfying parametric equations (11)-(20). All embodiments have the same basic structure of the lower resolution examples 1 and 3-7. That is, they have two positive power lens groups, group 1 and group 2, three lens elements in Group 1 and 1-3 lens elements in group 2. There is an aperture stop in group 1 and the three lens elements have optical powers of positive, negative, positive respectively. In some embodiments the second and third lens elements L2 and L3, in group 1, form a cemented doublet or an air gap doublet.

### Example 8

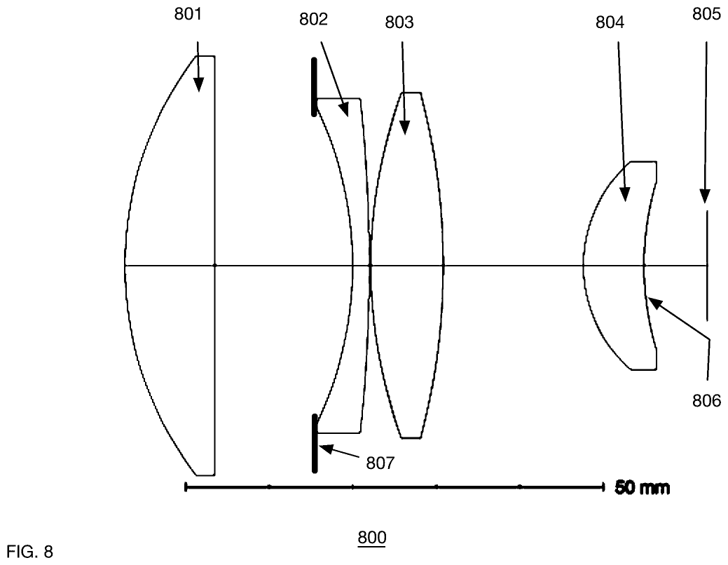

FIG. 8 shows the layout of an eighth embodiment of an imaging projection lens system 800. This design has a field angle of +/−10° with a relative aperture of F/0.75 and an effective focal length of 36.8 when used with a 12.8 mm (Ah) image source. The example of present invention shows an imaging lighting lens of a low F/#which has good optical efficiency and is high resolution.

It comprises two positive powered lens groups. Group 1 comprises L1 801, L2 802 and L3 803 and has an effective focal length of EFL_G1. An aperture stop 807 is located in group 1 at the object surface of L2. The optical powers of the lens elements in the first group are positive, negative, positive respectively. Group 2 comprises one lens element L4 804 and has an effective focal length of EFL_G2. The image surface 806 of the last element nearest the light source 805 has a radius of RL. All lens elements are spherical. All lens elements are made of glass material in order to achieve maximum thermal stability. The radius of curvature of individual lens shape is chosen to lower fabrication cost, stray light generation and aberration contribution. The absolute value of the radius of curvature of the lens surface |Ri| with the smallest radius of curvature is |R7|. Table 8 shows the optical prescription of Example 8.

TABLE 8

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | 10000.00 | | | |
| 1 | SPHERICAL | 40.90 | 10.77 | 1.568, 56.059 | 50.00 | L1 |
| 2 | SPHERICAL | Infinity | 16.49 | | 50.00 | |
| STO | SPHERICAL | −43.62 | 2.00 | 1.846, 23.787 | 37.92 | L2 |
| 4 | SPHERICAL | −178.18 | 0.20 | | 39.92 | |
| 5 | SPHERICAL | 59.94 | 8.63 | 1.620, 60.373 | 41.21 | L3 |
| 6 | SPHERICAL | −80.72 | 16.80 | | 40.78 | |
| 7 | SPHERICAL | 16.44 | 7.24 | 1.772, 49.613 | 24.80 | L4 |
| 8 | SPHERICAL | 33.61 | 7.60 | | 20.14 | |
| IMA | SPHERICAL | Infinity | | | 13.21 | |

[symbol]

indicates data missing or illegible when filed

The parametric equations (11)-(20) are satisfied:

| Parameter | Value |
|---|---|
| EFL | 36.80 |
| F-number | 0.75 |
| EFL_G1 | 1.73 |
| EFL_L1/EFL | 1.95 |
| EFL_L2/EFL | −1.90 |
| EFL_L3/EFL | 1.50 |
| EFL_G2/EFL | 0.95 |
| EFL_L4 | 0.95 |
| RL/EFL | 0.91 |
| TTL/Ah | 5.45 |
| EFL/Ah | 2.88 |
| R7/TTL | 0.24 |

### Example 9

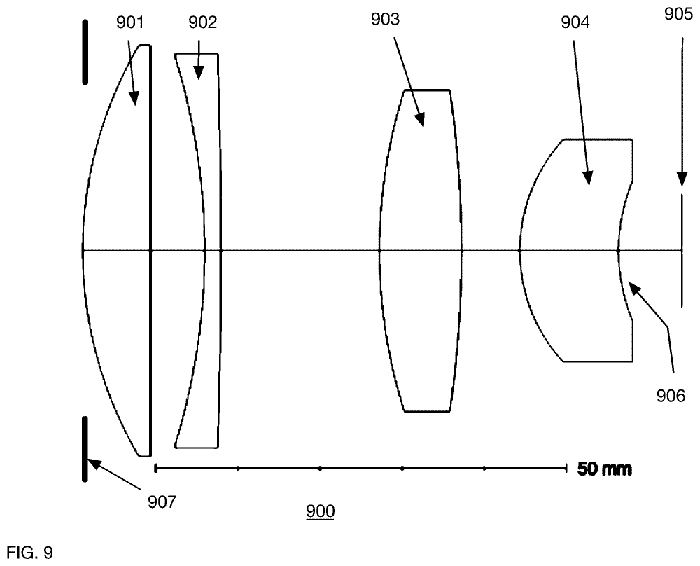

FIG. 9 shows the layout of another four lens embodiment of an imaging projection lens 900. This design has a field angle of +/−10° with a relative aperture of F/0.75 and an effective focal length of 36.8 when used with a 12.8 mm (Ah) image source. This example of the present invention shows an imaging lighting lens of a low F/#which has good optical efficiency and is high resolution.

It comprises two positive powered lens groups. Group 1 comprises L1 901, L2 902 and L3 903 and has an effective focal length of EFL_G1. An aperture stop 907 is located in group 1 at the object surface of L1. The optical powers of the lens elements in the first group are positive, negative, positive respectively. Group 2 comprises one lens element L4 904 and has an effective focal length of EFL_G2. The image surface 906 of the last element nearest the light source 905 has a radius of RL. All lens elements are spherical. All lens elements are made of glass material in order to achieve maximum thermal stability. The radius of curvature of individual lens shape is chosen to lower fabrication cost, stray light generation and aberration contribution. The absolute value of the radius of curvature of the lens surface |Ri| with the smallest radius of curvature is |R7|. Table 9 shows the optical prescription of Example 9.

TABLE 9

| | | | | | Clear | |
|---|---|---|---|---|---|---|
| Surf | Type | Radius | Thickness | ND, ABBE NO. | Diam [symbol] | LENS |
| OBJ | SPHERICAL | Infinity | 10000.00 | | 3526.54 | |
| STO | SPHERICAL | 48.80 | 8.24 | 1.772, 49.613 | 50.00 | L1 |
| 2 | SPHERICAL | Infinity | 6.61 | | 50.00 | |
| 3 | SPHERICAL | −78.77 | 2.00 | 1.846, 23.787 | 46.52 | L2 |
| 4 | SPHERICAL | −734.79 | 19.31 | | 48.00 | |
| 5 | SPHERICAL | 64.65 | 10.00 | 1.640, 60.213 | 39.00 | L3 |
| 6 | SPHERICAL | −135.03 | 7.11 | | 39.00 | |
| 7 | SPHERICAL | 19.86 | 12.00 | 1.772, 49.613 | 27.00 | L4 |
| 8 | SPHERICAL | 21.80 | 7.73 | | 17.10 | |
| IMA | SPHERICAL | Infinity | | | 13.77 | |

[symbol]

indicates data missing or illegible when filed

The parametric equations (11)-(20) are satisfied:

| | |
|---|---|
| EFL | 36.80 |
| F-number | 0.75 |
| EFL_G1/EFL | 1.576 |
| EFL_L1/EFL | 1.70 |
| EFL_L2/EFL | −2.80 |
| EFL_L3/EFL | 1.90 |
| EFL_G2/EFL | 2.10 |
| EFL_L4/EFL | 2.10 |
| RL/EFL | 0.59 |
| TTL/Ah | 5.70 |
| EFL/Ah | 2.88 |
| R7/TTL | 0.27 |

The minimum radius of curvature of all lens surfaces |Ri|, is |R7|.

### Example 10

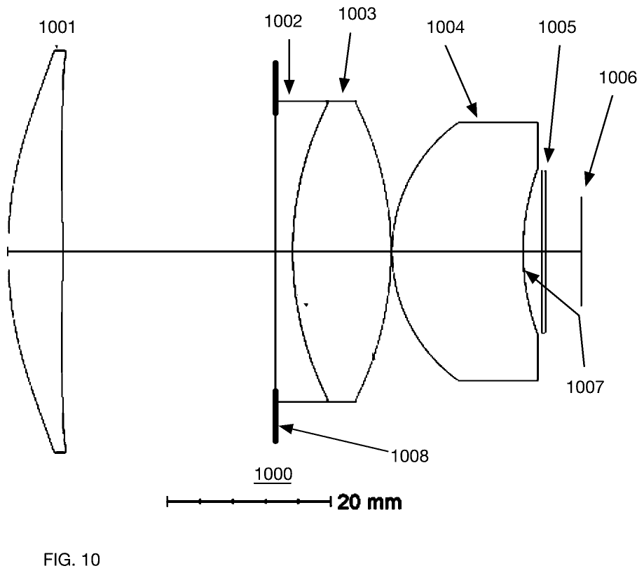

FIG. 10 shows the layout of another embodiment of a four lens imaging projection lens system 1000. This design has a field angle of +/−12° with a relative aperture of F/0.70 and an effective focal length of 30.9 when used with a 12.8 mm (Ah) image source. This example of a four lens imaging system shows an imaging lighting lens of a low F/#which has good optical efficiency and is high resolution.

It comprises two positive powered lens groups. Group 1 comprises L1 1001, L2 1002 and L3 1003 and has an effective focal length of EFL_G1. An aperture stop 1008 is located in group 1 at the object surface of L2. L2 and L3 form a cemented or air gap doublet. The optical powers of the lens elements in the first group are positive, negative, positive respectively. L1 is aspheric, where at least one of the two surfaces is aspheric. The power of aspheric element in group 1 is kept weak to ensure the stability of performance within working temperature range. Group 2 comprises one lens element L4 1004 and has an effective focal length of EFL_G2. The image surface 1007 of the last element nearest the light source 1006 has a radius of RL. The example includes a cover plate 1005. Surfaces 8 and 9 and the corresponding Nd and Abbe numbers in the prescription refer to this cover plate. The radius of curvature of individual lens shape is chosen to lower fabrication cost, stray light generation and aberration contribution. The absolute value of the radius of curvature of the lens surface |Ri| with the smallest radius of curvature is |R6|. Table 10 shows the optical prescription of Example 10.

TABLE 10

| | | | | | Clear | | |
|---|---|---|---|---|---|---|---|
| Surface | Type | Radius | Thickness | ND, ABBE NO. | Diam [symbol] | Conic | LENS |
| OBJ | SPHERICAL | Infinity | 10000.00 | | 4380.00 | 0.00 | |
| 1 | ASPHERICAL | 51.08 | 6.66 | 1.493, 50.887 | 48.92 | 0.00 | L1 |
| 2 | ASPHERICAL | −303.00 | 26.00 | | 48.33 | 0.00 | |
| STO | SPHERICAL | Infinity | 2.09 | 1.784, 25.719 | 36.66 | 0.00 | L2 |
| 4 | SPHERICAL | 39.99 | 12.00 | 1.622, 58.154 | 35.83 | 0.00 | L3 |
| 5 | SPHERICAL | −39.99 | 0.13 | | 35.72 | 0.00 | |
| 6 | SPHERICAL | 19.31 | 16.00 | 1.638, 55.471 | 31.36 | 0.00 | L4 |
| 7 | SPHERICAL | 29.63 | 2.22 | | 20.36 | 0.00 | |
| 8 | SPHERICAL | Infinity | 0.50 | 1.516, 64.212 | 19.79 | 0.00 | |
| 9 | SPHERICAL | Infinity | 4.35 | | 19.39 | 0.00 | |
| IMA | SPHERICAL | Infinity | | | 13.36 | 0.00 | |

[symbol]

indicates data missing or illegible when filed

Both surfaces of L1 are aspherical. The parameters for the equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

are:

### Object Surface of L1:

Coefficient on r²: 0
Coefficient on r⁴: 4.590e-06
Coefficient on r⁶: −1.543e-08
Coefficient on r⁸ 8.262e-12

### Image Surface of L1:

| | |
|---|---|
| Coefficient on r² | 0 |
| Coefficient on r⁴ | 1.040e−05 |
| Coefficient on r⁶ | −2.406e−08 |
| Coefficient on r⁸ | 2.246e−11 |

The conditions of parametric equations (11)-(20) are satisfied:

| parameter | Value |
|---|---|
| EFL | 30.9 |
| F-number | 0.70 |
| EFL_G1/EFL | 1.823 |
| EFL_L1/EFL | 2.9 |
| EFL_L2/EFL | −1.6 |
| EFL_L3/EFL | 1.1 |
| EFL_G2/EFL | 1.7 |
| EFL_L4/EFL | 1.7 |
| RL/EFL | 0.96 |
| TTL/Ah | 5.46 |
| EFL/Ah | 2.41 |
| R6/TTL | 0.28 |

### Example 11

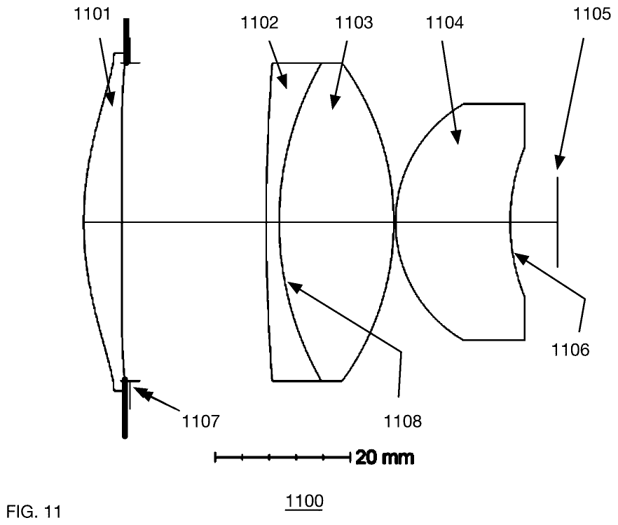

FIG. 11 shows the layout of an embodiment of a high resolution, four lens, imaging projection lens system 1100. This design has a field angle of +/−12° with a relative aperture of F/0.64 and an effective focal length of 30.2 mm. This example of the present invention shows an imaging lighting lens of a low F/#which has good optical efficiency and is high resolution.

It comprises two positive powered lens groups. Group 1 comprises L1 1101, L2 1102 and L3 1103 and has an effective focal length of EFL_G1. An aperture stop 1107 is located in group 1 at the image surface of L1. The optical powers of the lens elements in the first group are positive, negative, positive respectively. L1 is aspheric, where at least one of the two surfaces is aspheric. The power of aspheric element in group 1 is kept weak to ensure the stability of performance within working temperature range. L2 and L3 in Group 1 form a cemented or air gap doublet. The cemented surface 1108 is helpful in the reduction of blue fringes. Group 2 comprises one positive powered lens element L4 1104 and has an effective focal length of EFL_G2. The image surface 1106 of the last element nearest the light source 1105 has a radius of RL. The radius of curvature of individual lens shape is chosen to lower fabrication cost, stray light generation and aberration contribution. The absolute value of the radius of curvature of the lens surface |Ri| with the smallest radius of curvature is |R7|. Table 11 shows the optical prescription of Example 11.

TABLE 11

| | | | | | Clear | | |
|---|---|---|---|---|---|---|---|
| Surface | Type | Radius | Thickness | ND, ABBE NO. | Diam [symbol] | Conic | LENS |
| OBJ | SPHERICAL | Infinity | 10000.00 | | | 0.00 | |
| 1 | ASPHERICAL | 47.91 | 5.68 | 1.491, 57.440 | 50.00 | 0.00 | L1 |
| 2 | ASPHERICAL | 1622.92 | 1.23 | | 50.00 | 0.00 | |
| STO | SPHERICAL | Infinity | 20.18 | | 47.00 | 0.00 | |
| 4 | SPHERICAL | 319.11 | 1.91 | 1.846, 23.787 | 47.00 | 0.00 | L2 |
| 5 | SPHERICAL | 47.32 | 17.01 | 1.620, 60.373 | 47.00 | 0.00 | L3 |
| 6 | SPHERICAL | −40.02 | 0.26 | | 47.00 | 0.00 | |
| 7 | SPHERICAL | 20.23 | 17.00 | 1.620, 60.373 | 35.08 | 0.00 | L4 |
| 8 | SPHERICAL | 29.83 | 6.99 | | 22.37 | 0.00 | |
| IMA | SPHERICAL | Infinity | | | 13.31 | 0.00 | |

[symbol]

indicates data missing or illegible when filed

Both surfaces of L1 are aspheric. The parameters for the equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

are:

### Object Surface of L1:

| | |
|---|---|
| Coefficient on r² | 0 |
| Coefficient on r⁴ | −6.068e−06 |
| Coefficient on r⁶ | 5.829e−09 |
| Coefficient on r⁸ | −9.446e−12 |
| Coefficient on r¹⁰ | −1.2591e−15 |

### Image Surface of L1:

| | |
|---|---|
| Coefficient on r² | 0 |
| Coefficient on r⁴ | −2.27932e−06 |
| Coefficient on r⁶ | 5.8876e−09 |
| Coefficient on r⁸ | 1.6671e−14 |

The conditions of parametric equations (11)-(20) are satisfied:

| parameter | Value |
|---|---|
| EFL | 30.20 |
| F-number | 0.64 |
| EFL_G1/EFL | 1.796 |
| EFL_L1/EFL | 3.30 |
| EFL_L2/EFL | −2.20 |
| EFL_L3/EFL | 1.20 |
| EFL_G4/EFL | 2.00 |
| EFL_L4/EFL | 2.00 |
| RL/EFL | 0.99 |
| TTL/Ah | 5.49 |
| EFL/Ah | 2.36 |
| R7/TTL | 0.29 |

### Example 12

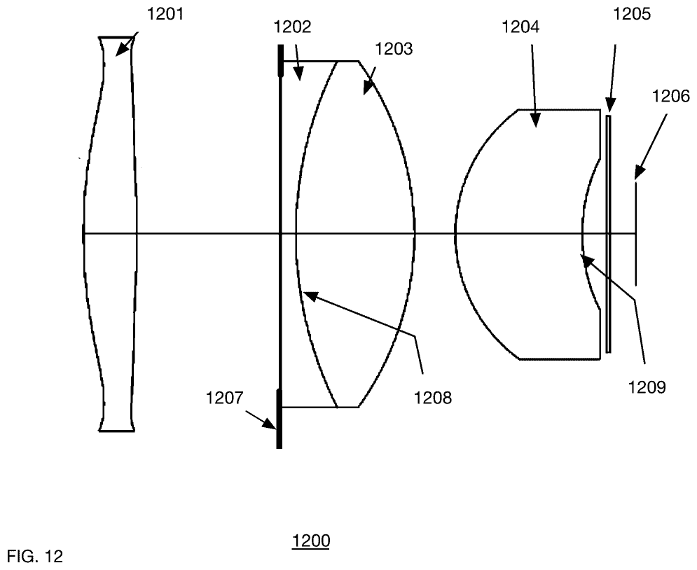

FIG. 12 shows the layout of Example 12. This design 1200 has a field angle of +/−12° with a relative aperture of F/0.70 and an effective focal length of 30.5. This example of the present invention shows an imaging lighting lens of a low F/#which has good optical efficiency and is high resolution.

It comprises two positive powered lens groups. Group 1 comprises L1 1201, L2 1202 and L3 1203 and has an effective focal length of EFL_G1. An aperture stop 1207 is located in group 1 at the object surface of L2. The optical powers of the lens elements in the first group are positive, negative, positive respectively. L1 is aspheric, where at least one of the two surfaces is aspheric. The power of aspheric element in group 1 is kept weak to ensure the stability of performance within working temperature range. L2 and L3 in Group 1 form a cemented or air gap doublet. The cemented surface 1208 is helpful in the reduction of blue fringes. Group 2 comprises one positive powered lens element L4 1204 and has an effective focal length of EFL_G2. The image surface 1209 of the last element nearest the light source 1206 has a radius of RL. A cover plate 1205 is included. The prescription values for R8 and R9 refer to this cover plate. The radius of curvature of individual lens shape is chosen to lower fabrication cost, stray light generation and aberration contribution. The absolute value of the radius of curvature of the lens surface |Ri| with the smallest radius of curvature is |R6|. Table 12 shows the optical prescription of Example 12.

TABLE 12

| | | | | | Clear | | |
|---|---|---|---|---|---|---|---|
| Surface | Type | Radius | Thickness | ND, ABBE NO. | Diam [symbol] | Conic | LENS |
| OBJ | SPHERICAL | Infinity | 10000.00 | | | 0.00 | |
| 1 | ASPHERICAL | 72.45 | 6.75 | 1.493, 53.961 | 50.00 | 0.00 | L1 |
| 2 | ASPHERICAL | −113.20 | 18.26 | | 50.00 | 0.00 | |
| STO | SPHERICAL | Infinity | 1.98 | 1.784, 25.719 | 43.70 | 0.00 | L2 |
| 4 | SPHERICAL | 48.55 | 15.05 | 1.622, 58.154 | 43.67 | 0.00 | L3 |
| 5 | SPHERICAL | −37.42 | 5.22 | | 43.97 | 0.00 | |
| 6 | SPHERICAL | 19.55 | 16.10 | 1.638, 55.471 | 31.73 | 0.00 | L4 |
| 7 | SPHERICAL | 21.59 | 3.08 | | 19.08 | 0.00 | |
| 8 | SPHERICAL | Infinity | 0.50 | 1.516, 64.212 | 30.00 | 0.00 | COVER |
| 9 | SPHERICAL | Infinity | 3.18 | | 30.00 | 0.00 | |
| IMA | SPHERICAL | Infinity | | | 13.08 | 0.00 | |

[symbol]

indicates data missing or illegible when filed

Both the object and image surfaces of L1 1201 are aspheric. The parameters for the aspheric equation,

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

are:

### Object Surface of L1:

| | |
|---|---|
| Coefficient on r² | 0 |
| Coefficient on r⁴ | 6.182e−06 |
| Coefficient on r⁶ | −2.009e−08 |
| Coefficient on r⁸ | 1.511e−14 |

### Image Surface of L1:

| | |
|---|---|
| Coefficient on r² | 0 |
| Coefficient on r⁴ | 3.1069e−05 |
| Coefficient on r⁶ | −1.6534e−07 |
| Coefficient on r⁸ | 5.061e−10 |
| Coefficient on r¹⁰ | −8.055e−13 |
| Coefficient on r¹² | 5.099e−16 |

The conditions of parametric equations (11)-(20) are satisfied:

| parameter | Value |
|---|---|
| EFL | 30.50 |
| F-number | 0.70 |
| EFL_G1/EFL | 1.659 |
| EFL_L1/EFL | 3.00 |
| EFL_L2/EFL | −2.00 |
| EFL_L3/EFL | 1.20 |
| EFL_G2/EFL | 2.60 |
| EFL_L4/EFL | 2.60 |
| RL/EFL | 0.71 |
| TTL/Ah | 5.48 |
| EFL/Ah | 2.38 |
| R6/TTL | 0.28 |

The next three Examples all include 2 lens elements in Group 2 or 5 lens elements total. Groups 1, as for all examples includes three lens elements with positive, negative, positive powers respectively. Group 2 in these examples includes two lens elements, L4 and L5 with powers positive, negative respectively. Group 2 in all of the examples has positive power and includes 1, 2 or 3 lens elements.

### Example 13

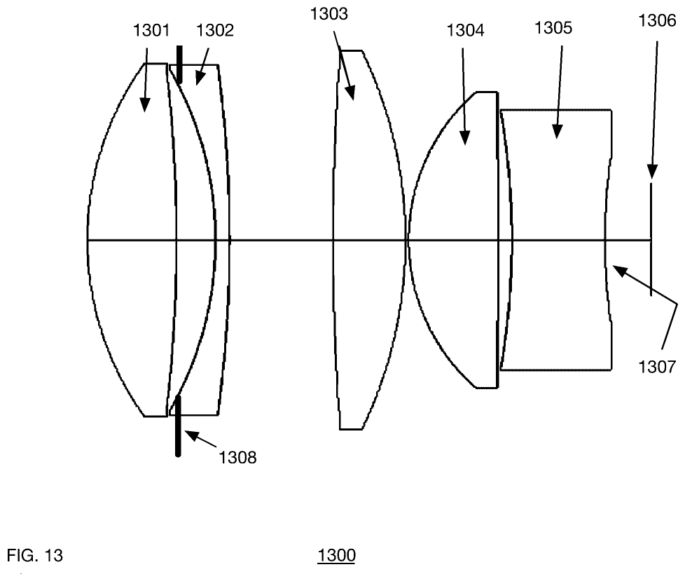

FIG. 13 shows the layout of a five lens element embodiment lens system 1300. This design has a field angle of +/−12° with a relative aperture of F/0.75 and an effective focal length of 30 when used with a 12.8 mm (Ah) image source. This example 13 of present invention shows an imaging lighting lens of low F/#which has very good optical efficiency and is also high resolution.

It comprises two positive powered lens groups. Group 1 comprises L1 1301, L2 1302 and L3 1303 and has an effective focal length of EFL_G1. An aperture stop 1308 is located in group 1 at the object surface of L2. The optical powers of the lens elements in the first group are positive, negative, positive respectively. Group 2 in this example has positive power and comprises positive powered lens element L4 1304 and negative powered lens element L5 1305. Group 2 has an effective focal length of EFL_G2. The image surface 1307 of the last element nearest the light source 1306 has a radius of RL. All lens elements are made of glass material in order to achieve maximum thermal stability. All lens elements are spherical. The radius of curvature of individual lens shape is chosen to lower fabrication cost, stray light generation and aberration contribution. The absolute value of the radius of curvature of the lens surface |Ri| with the smallest radius of curvature is |R7|. Table 13 shows the optical prescription of Example 13.

TABLE 13

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | Infinity | | 0.00 | |
| 1 | SPHERICAL | 34.10 | 10.12 | 1.516, 64.212 | 40.00 | L1 |
| 2 | SPHERICAL | −164.94 | 4.44 | | 38.84 | |
| STO | SPHERICAL | −38.43 | 1.59 | 1.728, 28.310 | 38.43 | L2 |
| 4 | SPHERICAL | −146.39 | 11.76 | | 39.74 | |
| 5 | SPHERICAL | 278.39 | 8.21 | 1.729, 54.669 | 42.80 | L3 |
| 6 | SPHERICAL | −48.97 | 0.36 | | 42.94 | |
| 7 | SPHERICAL | 22.16 | 10.17 | 1.622, 56.726 | 33.52 | L4 |
| 8 | SPHERICAL | −1723.26 | 1.56 | | 30.56 | |
| 9 | SPHERICAL | −85.42 | 10.59 | 1.728, 28.31 | 29.44 | L5 |
| 10 | SPHERICAL | 67.23 | 5.18 | | 18.95 | |
| IMA | SPHERICAL | Infinity | | | 12.93 | |

[symbol]

indicates data missing or illegible when filed

The parametric equations (11)-(20) are satisfied:

| Parameter | Value |
|---|---|
| EFL | 30.00 |
| F-Number | 0.75 |
| EFL_G1/EFL | 1.761 |
| EFL_L1/EFL | 1.85 |
| EFL_L2/EFL | −2.38 |
| EFL_L3/EFL | 1.92 |
| EFL_G2/EFL | 2.26 |
| EFL_L4 EFL | 1.169 |
| EFL_L5/EFL | −1.66 |
| RL/EFL | 2.24 |
| TTL/Ah | 5.00 |
| R7/TTL | 0.35 |
| EFL/Ah | 2.34 |

### Example 14

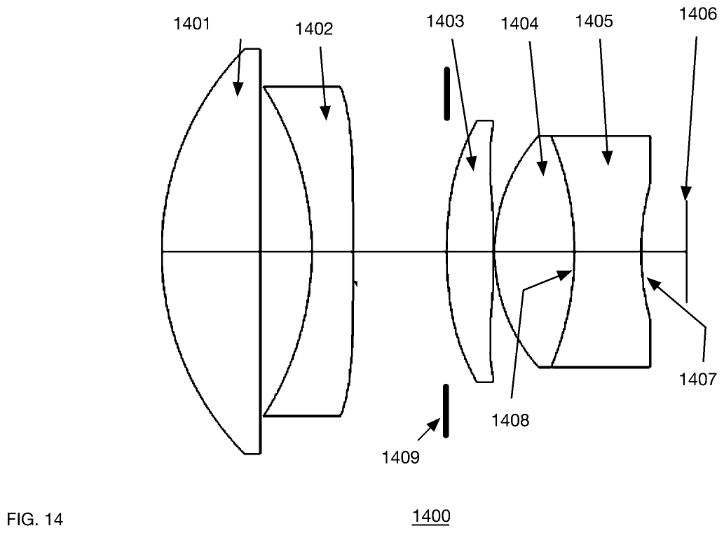

FIG. 14 shows the layout of a five lens element embodiment of an imaging lens system 1400. This design has a field angle of +/−12° with a relative aperture of F/0.68 and an effective focal length of 30.0. This example of present invention shows an imaging lighting lens of a low F/#which has good optical efficiency and is high resolution.

It comprises two positive powered lens groups. Group 1 comprises L1 1401, L2 1402 and L3 1403 and has an effective focal length of EFL_G1. An aperture stop 1409 is located in group 1 at the object surface of L3. The optical powers of the lens elements in the first group are positive, negative, positive respectively. L2 and L3 have a considerable spacing between them to maximize the correction effect of these aspheric elements. Further the combined optical power of L2 and L3 is kept large to achieve maximum thermal stability. Group 2 in this example has positive power and comprises positive powered lens element L4 1404 and negative powered lens element L5 1405. L4 and L5 form a cemented or air gap doublet. The cemented surface 1408 in group 2 is helpful in the reduction of blue fringes. Group 2 has an effective focal length of EFL_G2. The image surface 1407 of the last element nearest the light source 1406 has a radius of RL. The radius of curvature of individual lens shape is chosen to lower fabrication cost, stray light generation and aberration contribution. The absolute value of the radius of curvature of the lens surface |Ri| with the smallest radius of curvature is |R7|. Table 14 shows the optical prescription of Example 14.

TABLE 14

| | | | | Glass | Clear | | |
|---|---|---|---|---|---|---|---|
| Surface | Type | Radius | Thickness | nd, abbe no. | Diam | Conic | LENS |
| OBJ | SPHERICAL | Infinity | 10000.00 | | 4272.40 | 0.00 | |
| 1 | SPHERICAL | 35.62 | 12.21 | 1.670, 47.197 | 50.00 | 0.00 | L1 901 |
| 2 | SPHERICAL | Infinity | 6.36 | | 50.00 | 0.00 | |
| 3 | SPHERICAL | −37.66 | 5.10 | 1.585, 29.909 | 40.65 | 0.00 | L2 902 |
| 4 | ASPHERICAL | −1106.00 | 11.60 | | 40.50 | 0.00 | |
| STO | ASPHERICAL | 52.97 | 5.80 | 1.491, 57.948 | 32.25 | 0.87 | L3 903 |
| 6 | ASPHERICAL | −72.95 | 0.10 | | 31.39 | 13.78 | |
| 7 | SPHERICAL | 21.48 | 9.89 | 1.772, 49.613 | 28.54 | 0.00 | L4 904 |
| 8 | SPHERICAL | −36.61 | 8.25 | 1.784, 25.71 | 28.54 | 0.00 | L5 905 |
| 9 | SPHERICAL | 31.73 | 5.65 | | 16.70 | 0.00 | |
| IMA | SPHERICAL | Infinity | | | 12.65 | 0.00 | |

The image surface of L2 and both the image and the object surfaces of L3 are aspherical with the following aspheric formula parameters for the equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

### Image Surface of L2:

| | |
|---|---|
| Coefficient on r² | 0 |
| Coefficient on r⁴ | 6.316e−07 |
| Coefficient on r⁶ | −3.021e−08 |
| Coefficient on r⁸ | 2.324e−11 |

### Object Surface of L3:

| | |
|---|---|
| Coefficient on r² | 0 |
| Coefficient on r⁴ | 1.761e−05 |
| Coefficient on r⁶ | 3.681e−08 |
| Coefficient on r⁸ | −1.553e−10 |

### Image Surface of L3:

| | |
|---|---|
| Coefficient on r² | 0 |
| Coefficient on r⁴ | 3.400e−05 |

The parametric equations (11)-(20) are satisfied:

| Parameter | Value |
|---|---|
| EFL | 30.00 |
| F-number | 0.68 |
| EFL_G1/EFL | 1.916 |
| EFL_L1/EFL | 1.77 |
| EFL_L2/EFL | −2.21 |
| EFL_L3/EFL | 2.11 |
| EFL_G2/EFL | 1.67 |
| EFL_L4/EFL | 0.934 |
| EFL_L5/EFL | −1.317 |
| RL/EFL | 1.06 |
| TTL/Ah | 5.08 |
| EFL/Ah | 2.34 |
| R7/TTL | 0.33 |

### Example 15

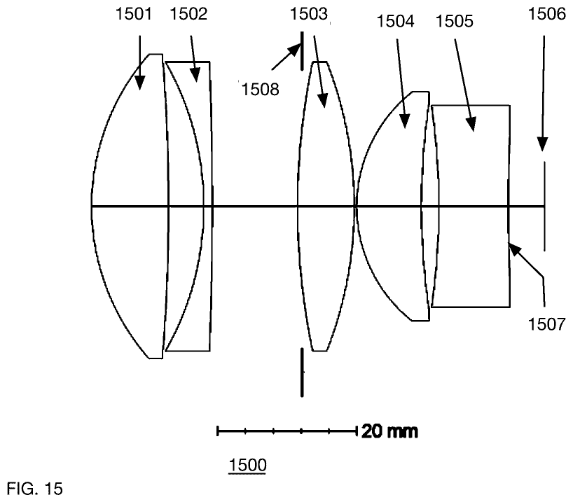

FIG. 15 shows the layout of Example 15 1500. This design has a field angle of +/−12° with a relative aperture of F/0.69 and an effective focal length of 30.0. The example of present invention shows an imaging lighting lens of low F/#which has very good optical efficiency and is high resolution.

It comprises two positive powered lens groups. Group 1 comprises L1 1501, L2 1502 and L3 1503 and has an effective focal length of EFL_G1. In preferred embodiment, the EFL_G1 should be equal or greater than 2 times the EFL of the whole lens in order to achieve maximum thermal stability. An aperture stop 1508 is located in group 1 at the object surface of L3. The stop location is closer to the light source to help with field aberration correction. The optical powers of the lens elements in the first group are positive, negative, positive respectively. Group 2 has positive power and comprises positive powered lens element L4 1504 and negative powered lens element L5 1505. Group 2 has an effective focal length of EFL_G2. The image surface 1507 of the last element nearest the light source 1506 has a radius of RL. All lens elements are spherical and all lens elements are made of glass material in order to achieve maximum thermal stability. The radius of curvature of individual lens shape is chosen to lower fabrication cost, stray light generation and aberration contribution. The absolute value of the radius of curvature of the lens surface |Ri| with the smallest radius of curvature is |R7|. Table 15 shows the optical prescription of Example 15.

TABLE 15

| | | | | | Clear | |
|---|---|---|---|---|---|---|
| Surf ace | Type | Radius | Thickness | ND, ABBE NO. | Diam [symbol] | LENS |
| OBJ | SPHERICAL | Infinity | 10000.00 | | | |
| 1 | SPHERICAL | 33.00 | 11.04 | 1.516, 64.212 | 43.62 | L1 |
| 2 | SPHERICAL | −262.21 | 5.04 | | 42.01 | |
| 3 | SPHERICAL | −41.87 | 1.20 | 1.728, 28.310 | 41.55 | L2 |
| 4 | SPHERICAL | −544.85 | 12.25 | | 41.48 | |
| STO | SPHERICAL | 99.64 | 8.12 | 1.729, 54.669 | 41.50 | L3 |
| 6 | SPHERICAL | −56.59 | 0.37 | | 41.45 | |
| 7 | SPHERICAL | 20.98 | 9.30 | 1.622, 56.726 | 32.85 | L4 |
| 8 | SPHERICAL | 103.73 | 2.48 | | 29.76 | |
| 9 | SPHERICAL | −100.85 | 9.97 | 1.728, 28.310 | 28.90 | L5 |
| 10 | SPHERICAL | 218.32 | 5.23 | | 20.17 | |
| IMA | SPHERICAL | Infinity | | | 12.94 | |

[symbol]

indicates data missing or illegible when filed

The parametric equations (11)-(20) are satisfied.

| Parameter | Value |
|---|---|
| EFL | 30.00 |
| F-Number | 0.69 |
| EFL_G1/EFL | 1.76 |
| EFL_L1/EFL | 1.91 |
| EFL_L2/EFL | −2.06 |
| EFL_L3/EFL | 1.68 |
| EFL_G2/EFL | 1.96 |
| EFL_L4/EFL | 1.345 |
| EFL_L5/EFL | −3.093 |
| R_{L}/EFL | 7.28 |
| TTL/Ah | 5.08 |
| R7/TTL | 0.32 |
| EFL/Ah | 2.34 |

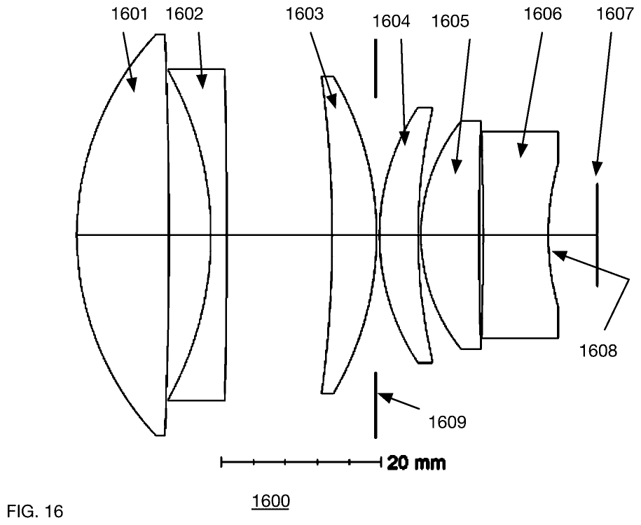

The examples 16-26, as shown in FIGS. 16-26 have 3 lens elements in Group 2 or six lens elements total. Group 1 remains the same with 3 lens elements of positive, negative, positive powers. An aperture stop is included in Group 1. L2 and L3 in Group 1 form a cemented or air gap doublet in some embodiments. All of group 2, three element embodiments include, a first positive, a second positive and a third, negative, lens element. The order in most examples is positive, positive negative ordering as always from object to image. Example 18 shows the case where the order is positive, negative, positive. L5 and L6 of Group 2, in all three lens element embodiments, form a doublet lens.

### Example 16

FIG. 16 shows an embodiment of an imaging projection lens system 1600, that has three lens elements in Group 2 or six lens elements total. This design has a field angle of +/−12° with a relative aperture of F/0.70 and an effective focal length of 30.0. The example of present invention shows an imaging lighting lens of a low F/#which has good optical efficiency and is high resolution.

It comprises two positive powered lens groups. Group 1 comprises L1 1601, L2 1602 and L3 1603 and has an effective focal length of EFL_G1. In preferred embodiment, the EFL_G1 should be equal or greater than 2 times the EFL of the whole lens in order to achieve maximum thermal stability. An aperture stop 1609 is located in group 1 at the image surface of L3. The stop location is closer to the light source to help with field aberration correction. The optical powers of the lens elements in the first group are positive, negative, positive respectively.

Group 2 has positive power and comprises positive powered lens element L4 1604, positive powered lens element L5 1605 and negative powered lens element L6 1606. L5 and L6 function together as an air spaced doublet. Group 2 has an effective focal length of EFL_G2. The image surface 1608 of the last element nearest the light source 1607 has a radius of RL. All lens elements are spherical and all lens elements are made of glass material in order to achieve maximum thermal stability. The radius of curvature of individual lens shape is chosen to lower fabrication cost, stray light generation and aberration contribution. The absolute value of the radius of curvature of the lens surface |Ri| with the smallest radius of curvature is |R9|. Table 16 shows the optical prescription of Example 16.

TABLE 16

| | | | | | Clear | |
|---|---|---|---|---|---|---|
| Surface | Type | Radius | Thickness | ND, ABBE NO. | Diam [symbol] | LENS |
| OBJ | SPHERICAL | Infinity | 10000.00 | | | |
| 1 | SPHERICAL | 36.51 | 11.50 | 1.658, 50.866 | 50.00 | L1 |
| 2 | SPHERICAL | −650.40 | 5.25 | | 50.00 | |
| 3 | SPHERICAL | −41.99 | 2.00 | 1.728, 28.310 | 41.19 | L2 |
| 4 | SPHERICAL | −780.20 | 13.10 | | 40.25 | |
| 5 | SPHERICAL | −145.30 | 5.55 | 1.620, 60.373 | 39.40 | L3 |
| 6 | SPHERICAL | −38.69 | 0.37 | | 39.51 | |
| STO | SPHERICAL | 28.77 | 4.80 | 1.620, 60.373 | 31.88 | L4 |
| 8 | SPHERICAL | 68.45 | 0.37 | | 30.85 | |
| 9 | SPHERICAL | 22.56 | 7.25 | 1.620, 60.373 | 28.44 | L5 |
| 10 | SPHERICAL | 367.70 | 0.51 | | 26.01 | |
| 11 | SPHERICAL | −447.70 | 8.13 | 1.728, 28.310 | 25.83 | L6 |
| 12 | SPHERICAL | 32.39 | 6.11 | | 17.77 | |
| IMA | SPHERICAL | Infinity | | | 12.90 | |

[symbol]

indicates data missing or illegible when filed

The parametric conditions of equations (11)-(20) are satisfied:

| parameter | Value |
|---|---|
| EFL | 30.00 |
| F-number | 0.70 |
| EFL_G1/EFL | 2.36 |
| EFL_L1/EFL | 1.75 |
| EFL_L2/EFL | −2.02 |
| EFL_L3/EFL | 2.77 |
| EFL_G2/EFL | 1.42 |
| EFL_L4/EFL | 2.54 |
| EFL_L5/EFL | 1.28 |
| EFL_L6/EFL | −1.36 |
| RL/EFL | 1.08 |
| TTL/Ah | 4.67 |
| EFL/Ah | 2.34 |
| R9/TTL | 0.38 |

### Example 17

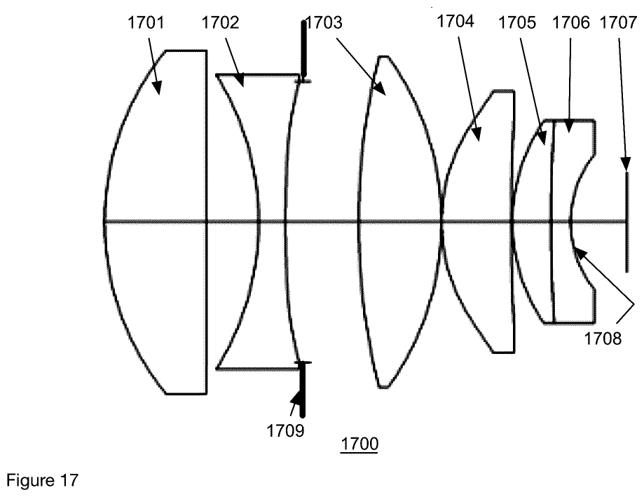

FIG. 17 shows the layout of Example 17, another embodiment 1700 with three lens elements in group 2. This design has a field angle of +/−12° with a relative aperture of F/0.73 and an effective focal length EFL of 30.5 when used with a 12.8 mm (Ah) image source. The embodiment of an imaging projection lens system shows an imaging lighting lens of a low F/#which has good optical efficiency and is high resolution.

It comprises two positive powered lens groups. Group 1 comprises L1 1701, L2 1702 and L3 1703 and has an effective focal length of EFL_G1. In preferred embodiment, the EFL_G1 should be equal or greater than 2 times the EFL of the whole lens in order to achieve maximum thermal stability. An aperture stop 1709 is located in group 1 at the image surface of L2. The optical powers of the lens elements in the first group are positive, negative, positive respectively. Group 2 has positive power and comprises positive powered lens element L4 1704, positive powered lens element L5 1705 and negative powered lens element L6 1706. L5 and L6 function together as an air spaced doublet. Group 2 has an effective focal length of EFL_G2. The image surface 1708 of the last element nearest the light source 1707 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R12|. Table 17 shows the optical prescription of Example 17.

TABLE 17A

| Surface | Surface | | | | Material | Clear | |
|---|---|---|---|---|---|---|---|
| ID | Type | Lens | Radius | Thickness | Nd/Abbe | Semi | Conic |
| 0 | STANDARD | | Infinity | 1.00E+04 | | 2.13E+03 | 0.00E+00 |
| 1 | STANDARD | L1 | 35.3 | 1.32E+01 | 1.620, 60.374 | 2.24E+01 | 0.00E+00 |
| 2 | STANDARD | | Infinity | 6.78E+00 | | 2.02E+01 | 0.00E+00 |
| 3 | STANDARD | L2 | −36.0 | 3.48E+00 | 1.585, 29.909 | 1.91E+01 | 0.00E+00 |
| 4 | EVENASPH | | 171 | 2.26E+00 | | 1.82E+01 | 0.00E+00 |
| 5 | STANDARD | stop | Infinity | 7.21E+00 | | 1.83E+01 | 0.00E+00 |
| 6 | STANDARD | L3 | 88.3 | 1.08E+01 | 1.620, 60.374 | 2.13E+01 | 0.00E+00 |
| 7 | STANDARD | | −36.8 | 0.00E+00 | | 2.15E+01 | 0.00E+00 |
| 8 | EVENASPH | L4 | 22.5 | 9.12E+00 | 1.492, 57.949 | 1.70E+01 | −1.37E+00 |
| 9 | EVENASPH | | 811 | 1.01E−01 | | 1.59E+01 | 0.00E+00 |
| 10 | STANDARD | L5 | 23.2 | 5.02E+00 | 1.773, 49.613 | 1.32E+01 | 0.00E+00 |
| 11 | STANDARD | L6 | 21.8 | 2.54E+00 | 1.847, 23.787 | 1.32E+01 | 0.00E+00 |
| 12 | STANDARD | | 14.0 | 7.31E+00 | | 8.78E+00 | 0.00E+00 |
| 13 | STANDARD | | Infinity | 0.00E+00 | | 6.55E+00 | 0.00E+00 |

TABLE 17B

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | 8.58E−06 | 1.44E−05 | 1.62E−05 |
| r\hat{ }6 | −1.09E−08 | 3.26E−08 | 1.62E−05 |
| r\hat{ }8 | 2.68E−11 | −2.00E−10 | 2.96E−11 |

The conditions of parametric equations (11)-(20) are satisfied:

| Parameter | Value |
|---|---|
| EFL | 30.5 |
| F-number | 0.73 |
| EFL_G1/EFL | 1.742 |
| EFL_L1/EFL | 1.86 |
| EFL_L2/EFL | −1.65 |
| EFL_L3/EFL | 1.42 |
| EFL_G2/EFL | 3.05 |
| EFL_L4/EFL | 1.54 |
| EFL_L5/EFL | 0.97 |
| EFL_L6/EFL | −0.54 |
| RL/EFL | 0.46 |
| TTL/Ah | 5.30 |
| EFL/Ah | 2.38 |
| R12/TTL | 0.21 |

### Example 18

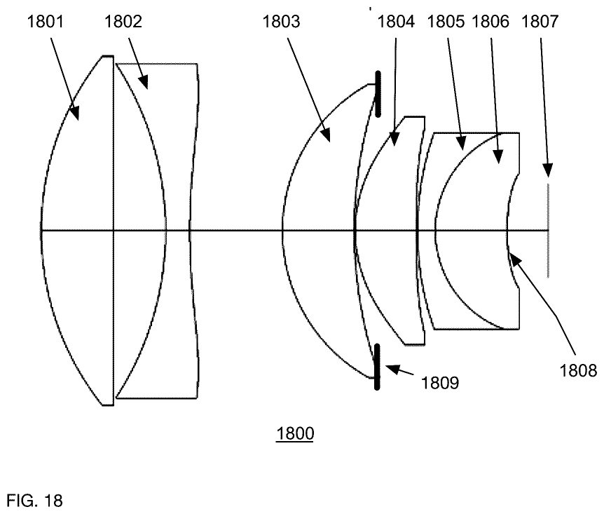

FIG. 18 shows the 6 lens element layout of Example 18. This design has a field angle of +/−12° with a relative aperture of F/0.68 and an effective focal length EFL of 30.7 when used with a 12.8 mm (Ah) image source. The embodiment of an imaging projection lens system 1800 shows an imaging lighting lens of a low F/#which has good optical efficiency and is high resolution.

It comprises two positive powered lens groups. Group 1 comprises L1 1801, L2 1802 and L3 1803 and has an effective focal length of EFL_G1. In preferred embodiment, the EFL_G1 should be equal or greater than 2 times the EFL of the whole lens in order to achieve maximum thermal stability. An aperture stop 1809 is located in group 1 at the image surface of L3. The stop location is closer to the light source to help with field aberration correction. The optical powers of the lens elements in the first group are positive, negative, positive respectively. Group 2 has positive power and comprises two positive powered and one negative powered lens elements in the order: positive powered lens element L4 1804, negative powered L5 1805 and positive powered lens element L6 1806. L5 and L6 function together as an air spaced doublet.

Group 2 has an effective focal length of EFL_G2. The image surface 1808 of the last element nearest the light source 1807 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R10|. Table 18 shows the optical prescription of Example 18.

TABLE 18A

| Surface | Surface | | | | | Clear | |
|---|---|---|---|---|---|---|---|
| ID | Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 39.4 | 1.03E+01 | 1.620, 60.374 | 2.47E+01 | 0.00E+00 |
| 2 | STANDARD | | Infinity | 7.39E+00 | | 2.41E+01 | 0.00E+00 |
| 3 | STANDARD | L2 | −43.0 | 3.44E+00 | 1.585, 29.909 | 2.35E+01 | 0.00E+00 |
| 4 | EVENASPH | | 89.4 | 1.32E+01 | | 2.37E+01 | 0.00E+00 |
| 5 | STANDARD | L3 | 23.70 | 1.02E+01 | 1.620, 60.374 | 2.08E+01 | 0.00E+00 |
| 6 | STANDARD | | 61.70 | 1.36E−01 | | 2.08E+01 | 0.00E+00 |
| 7 | EVENASPH | L4(stop) | 19.00 | 8.73E+00 | 1.492, 57.949 | 1.61E+01 | −1.37E+00 |
| 8 | EVENASPH | | −16800 | 1.01E−01 | | 1.47E+01 | 0.00E+00 |
| 9 | STANDARD | L5 | 41.60 | 2.54E+00 | 1.805, 25.477 | 1.39E+01 | 0.00E+00 |
| 10 | STANDARD | L6 | 14.80 | 1.02E+01 | 1.744, 44.904 | 1.39E+01 | 0.00E+00 |
| 11 | STANDARD | | 27.10 | 5.87E+00 | | 8.09E+00 | 8.11E+00 |
| 12 | STANDARD | | Infinity | 0.00E+00 | | 6.66E+00 | 0.00E+00 |

TABLE 18B

| | EVENASPH for | EVENASPH for | EVENASPH for |
|---|---|---|---|
| | Image Surface | Object Surface | Image Surface |
| Coefficients | of L2 | of L4 | of L4 |
| r\hat{ }4 | −3.91E−06 | 1.25E−05 | 4.00E−05 |
| r\hat{ }6 | −8.35E−09 | 4.26E−08 | −7.78E−08 |
| r\hat{ }8 | 4.44E−12 | −2.17E−10 | 4.19E−11 |

The conditions of parametric equations (11)-(20) are satisfied:

| Parameter | Value |
|---|---|
| EFL | 30.7 |
| F-number | 0.68 |
| EFL_G1/EFL | 2.37 |
| EFL_F1/EFL | 2.06 |
| EFL_F2/EFL | −1.59 |
| EFL_F3/EFL | 1.83 |
| EFL_G2/EFL | 1.37 |
| EFL_L4/EFL | 1.25 |
| EFL_L5/EFL | 2.13 |
| EFL_L6/EFL | −1.00 |
| RL/EFL | 0.88 |
| TTL/Ah | 5.63 |
| EFL/Ah | 2.40 |
| R10/TTL | 0.21 |

### Example 19

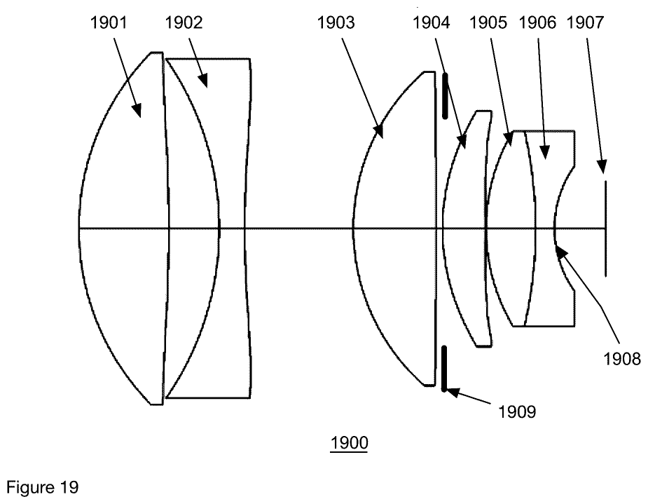

FIG. 19 shows the layout of an embodiment with three lens elements in group 2, Example 14. This design has a field angle of +/−12° with a relative aperture of F/0.67 and an effective focal length EFL of 30.8. The embodiment of an imaging projection lens system 1900 shows an imaging lighting lens of a low F/#which has good optical efficiency and is high resolution.

It comprises two positive powered lens groups. Group 1 comprises L1 1901, L2 1902 and L3 1903 and has an effective focal length of EFL_G1. In preferred embodiment, the EFL_G1 should be equal or greater than 2 times the EFL of the whole lens in order to achieve maximum thermal stability. An aperture stop 1909 is located in group 1 at the image surface of L3. The stop location is closer to the light source to help with field aberration correction. The optical powers of the lens elements in the first group are positive, negative, positive respectively. Group 2 has positive power and comprises positive powered lens element L4 1904, positive powered lens element L5 1905 and negative powered lens element L6 1906. L5 and L6 function together as an air spaced doublet. Group 2 has an effective focal length of EFL_G2. The image surface 1908 of the last element nearest the light source 1907 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 19 shows the optical prescription of Example 19.

TABLE 19A

| Surface | Surface | | | | | Clear | |
|---|---|---|---|---|---|---|---|
| ID | Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 34.3 | 1.23E+01 | 1.492, 57.441 | 2.41E+01 | 0.00E+00 |
| 2 | EVENASPH | | −177 | 6.88E+00 | | 2.35E+01 | 0.00E+00 |
| 3 | STANDARD | L2 | −40.7 | 3.48E+00 | 1.585, 29.909 | 2.32E+01 | 0.00E+00 |
| 4 | EVENASPH | | 136 | 1.48E+01 | | 2.31E+01 | 0.00E+00 |
| 5 | STANDARD | L3 | 28.7 | 1.13E+01 | 1.620, 60.374 | 2.15E+01 | 0.00E+00 |
| 6 | STANDARD | | −2.42E+03 | 9.26E−01 | | 2.08E+01 | 0.00E+00 |
| 7 | EVENASPH | L4 (stop) | 2.94E+01 | 5.85E+00 | 1.694, 53.151 | 1.61E+01 | −5.14E−01 |
| 8 | EVENASPH | | −1.05E+03 | 9.82E−02 | | 1.52E+01 | 0.00E+00 |
| 9 | STANDARD | L5 | 2.62E+01 | 6.76E+00 | 1.773, 49.613 | 1.34E+01 | 0.00E+00 |
| 10 | STANDARD | L6 | −5.90E+01 | 2.57E+00 | 1.847, 23.787 | 1.34E+01 | 0.00E+00 |
| 11 | STANDARD | | 1.48E+01 | 7.03E+00 | | 8.52E+00 | 0.00E+00 |
| 12 | STANDARD | | Infinity | 0.00E+00 | | 6.53E+00 | 0.00E+00 |

TABLE 19B

| | EVENASPH for | EVENASPH for | EVENASPH for | EVENASPH for |
|---|---|---|---|---|
| | Image Surface | Image Surface | Object Surface | Image Surface |
| Coefficients | of L1 | of L2 | of L4 | of L4 |
| r\hat{ }4 | 2.79E−06 | −2.18E−06 | 5.58E−06 | 2.41E−05 |
| r\hat{ }6 | −7.19E−10 | −6.49E−09 | −2.54E−08 | −5.79E−08 |
| r\hat{ }8 | | 3.91E−12 | 2.86E−11 | 1.30E−10 |

parametric expressions (11)-(20) are satisfied:

| Parameter | Value |
|---|---|
| EFL | 30.8 |
| F-number | 0.67 |
| EFL_G1/EFL | 1.79 |
| EFL_L1/EFL | 1.93 |
| EFL_L2/EFL | −1.71 |
| EFL_L3/EFL | 1.48 |
| EFL_G2/EFL | 2.51 |
| EFL_L4/EFL | 1.34 |
| EFL_L5/EFL | 1.14 |
| EFL_L6/EFL | −0.55 |
| RL/EFL | 0.48 |
| TTL/Ah | 5.62 |
| EFL/Ah | 2.41 |
| R11/TTL | 0.21 |

### Example 20

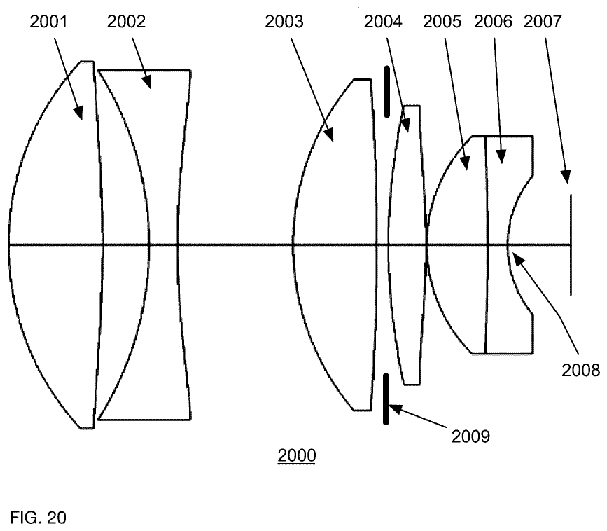

FIG. 20 shows the layout of Example 20. This design has a field angle of +/−12° with a relative aperture of F/0.7 and an effective focal length EFL of 30.8 when used with a 12.8 mm (Ah) image source. The 20th embodiment of an imaging projection lens system 2000 shows an imaging lighting lens of a low F/#which has good optical efficiency and is high resolution.

It comprises two positive powered lens groups. Group 1 comprises L1 2001, L2 2002 and L3 2003 and has an effective focal length of EFL_G1. In preferred embodiment, the EFL_G1 should be equal or greater than 2 times the EFL of the whole lens in order to achieve maximum thermal stability. An aperture stop 2009 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2004, positive powered lens element L5 2005 and negative powered lens element L6 2006. L5 and L6 function together as an air spaced doublet. Group 2 has an effective focal length of EFL_G2. The image surface 2008 of the last element nearest the light source 2007 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 20 shows the optical prescription of Example 20.

TABLE 20A

| Surface | Surface | | | | | Clear | |
|---|---|---|---|---|---|---|---|
| ID | Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 3.43E+01 | 1.20E+01 | 1.492, 57.441 | 2.34E+01 | 0.00E+00 |
| 2 | EVENASPH | | −1.45E+02 | 5.96E+00 | | 2.27E+01 | 0.00E+00 |
| 3 | STANDARD | L2 | −4.12E+01 | 3.64E+00 | 1.585, 29.909 | 2.23E+01 | 0.00E+00 |
| 4 | EVENASPH | | 9.88E+01 | 1.48E+01 | | 2.18E+01 | 0.00E+00 |
| 5 | STANDARD | L3 | 3.25E+01 | 1.07E+01 | 1.620, 60.374 | 2.11E+01 | 0.00E+00 |
| 6 | STANDARD | | −2.70E+02 | 1.46E+00 | | 2.04E+01 | 0.00E+00 |
| 7 | EVENASPH | L4(stop) | 7.60E+01 | 4.81E+00 | 1.694, 53.151 | 1.77E+01 | 5.46E+00 |
| 8 | EVENASPH | | −9.18E+01 | 9.98E−02 | | 1.70E+01 | 0.00E+00 |
| 9 | STANDARD | L5 | 1.94E+01 | 7.82E+00 | 1.773, 49.613 | 1.39E+01 | 0.00E+00 |
| 10 | STANDARD | L6 | −2.41E+02 | 2.54E+00 | 1.847, 23.787 | 1.28E+01 | 0.00E+00 |
| 11 | STANDARD | | 1.38E+01 | 8.13E+00 | | 8.87E+00 | 0.00E+00 |
| 12 | STANDARD | | Infinity | 0.00E+00 | | 6.45E+00 | 0.00E+00 |

TABLE 20B

| | EVENASPH for | EVENASPH for | EVENASPH for | EVENASPH for |
|---|---|---|---|---|
| | Image Surface | Image Surface | Object Surface | Image Surface |
| Coefficients | of L1 | of L2 | of L4 | of L4 |
| r\hat{ }4 | 3.76E−06 | −3.05E−06 | 6.25E−07 | 1.25E−05 |
| r\hat{ }6 | −2.50E−09 | 8.46E−10 | −3.52E−08 | −3.50E−08 |
| r\hat{ }8 | | −3.40E−12 | 7.38E−11 | 8.94E−11 |

Parametric expressions (11)-(20) are satisfied.

| Parameter | Value |
|---|---|
| EFL | 30.80 |
| F-number | 0.70 |
| EFL_G1/EFL | 1.87 |
| EFL_L1/EFL | 1.86 |
| EFL_L2/EFL | −1.59 |
| EFL_L3/EFL | 1.53 |
| EFL_G2/EFL | 2.20 |
| EFL_L4/EFL | 1.96 |
| EFL_L5/EFL | 0.82 |
| EFL_L6/EFL | −0.52 |
| RL/EFL | 0.45 |
| TTL/Ah | 5.62 |
| EFL/Ah | 2.41 |
| R11/TTL | 0.19 |

### Example 21

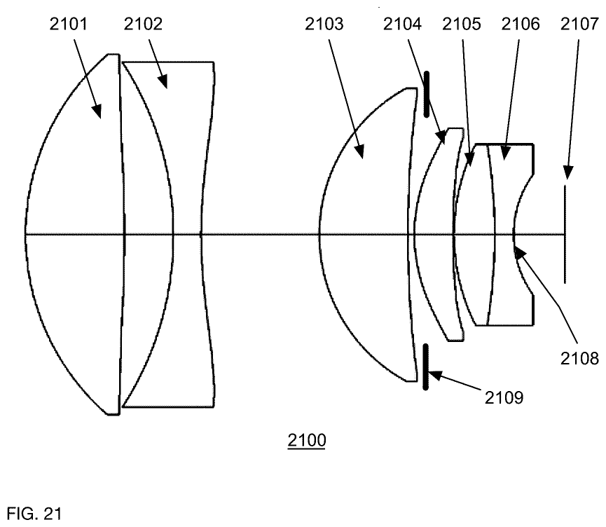

FIG. 21 shows the layout of Example 21. This design has a field angle of +/−12° with a relative aperture of F/0.69 and an effective focal length EFL of 30.8 when used with a 12.8 mm (Ah) image source. The embodiment of an imaging projection lens system 2100 shows an imaging lighting lens of a low F/#which has good optical efficiency and is high resolution.

It comprises two positive powered lens groups. Group 1 comprises L1 2101, L2 2102 and L3 2103 and has an effective focal length of EFL_G1. In preferred embodiment, the EFL_G1 should be equal or greater than 2 times the EFL of the whole lens in order to achieve maximum thermal stability. An aperture stop 2109 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2104, positive powered lens element L5 2105 and negative powered lens element L6 2106. L5 and L6 function together as an air spaced doublet. Group 2 has an effective focal length of EFL_G2. The image surface 2108 of the last element nearest the light source 2107 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 21 shows the optical prescription of Example 21.

TABLE 21A

| Surface | | | | | | Clear | |
|---|---|---|---|---|---|---|---|
| ID | Surface Type | Lens | Radius | Thickness | Material | Semi | Conic |
| 0 | STANDARD | | Infinity | 1.00E+04 | | 2.14E+03 | 0.00E+00 |
| 1 | STANDARD | L1 | 3.18E+01 | 1.32E+01 | 1.492, 57.441 | 2.40E+01 | 0.00E+00 |
| 2 | EVENASPH | | −1.57E+02 | 6.54E+00 | | 2.33E+01 | 0.00E+00 |
| 3 | STANDARD | L2 | −4.21E+01 | 3.69E+00 | 1.585, 29.909 | 2.30E+01 | 0.00E+00 |
| 4 | EVENASPH | | 6.47E+01 | 1.57E+01 | | 2.23E+01 | 0.00E+00 |
| 5 | STANDARD | L3 | 2.22E+01 | 1.18E+01 | 1.620, 60.374 | 1.95E+01 | 0.00E+00 |
| 6 | STANDARD | | 1.43E+02 | 8.74E−01 | | 1.86E+01 | 0.00E+00 |
| 7 | EVENASPH | L4(stop) | 2.15E+01 | 5.19E+00 | 1.694, 53.151 | 1.41E+01 | −4.88E−01 |
| 8 | EVENASPH | | 1.56E+02 | 9.91E−02 | | 1.30E+01 | 0.00E+00 |
| 9 | STANDARD | L5 | 2.67E+01 | 5.42E+00 | 1.773, 49.613 | 1.20E+01 | 0.00E+00 |
| 10 | STANDARD | L6 | −7.36E+01 | 2.54E+00 | 1.847, 23.787 | 1.20E+01 | 0.00E+00 |
| 11 | STANDARD | | 1.37E+01 | 6.85E+00 | | 8.01E+00 | 0.00E+00 |
| 12 | STANDARD | | Infinity | 0.00E+00 | | 6.47E+00 | 0.00E+00 |

TABLE 21B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 5.42E−06 | −8.63E−06 | 5.43E−06 | 3.99E−05 |
| r\hat{ }6 | −3.35E−09 | −1.42E−09 | −8.03E−08 | −1.76E−07 |
| r\hat{ }8 | | 3.65E−13 | −1.44E−12 | 6.14E−10 |

Parametric expressions (11)-(20) are satisfied:

| Parameter | Value |
|---|---|
| EFL | 30.80 |
| F-number | 0.69 |
| EFL_G1/EFL | 1.74 |
| EFL_L1/EFL | 1.78 |
| EFL_L2/EFL | −1.39 |
| EFL_L3/EFL | 1.32 |
| EFL_G2/EFL | 2.58 |
| EFL_L4/EFL | 1.15 |
| EFL_L5/EFL | 1.15 |
| EFL_L6/EFL | −0.51 |
| RL/EFL | 0.44 |
| TTL/Ah | 5.62 |
| EFL/Ah | 2.41 |
| R11/TTL | 0.19 |

### Example 22

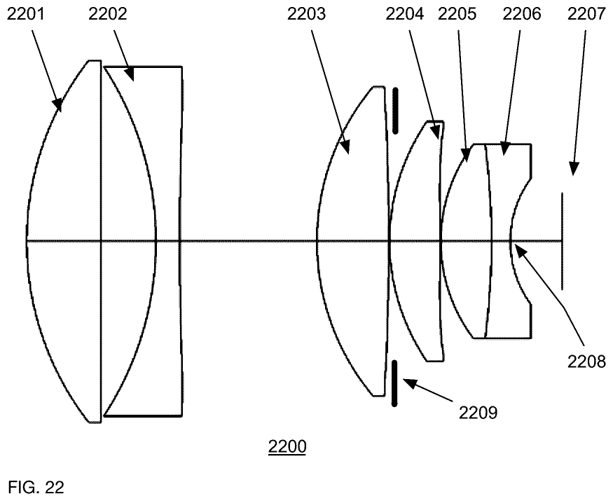

FIG. 22 shows the layout of Example 22. This design has a field angle of +/−12° with a relative aperture of F/0.67 and an effective focal length EFL of 30.8 when used with a 12.8 mm (Ah) image source. The embodiment of an imaging projection lens system 2200 shows an imaging lighting lens of a low F/#which has good optical efficiency and is high resolution.

It comprises two positive powered lens groups. Group 1 comprises L1 2201, L2 2202 and L3 2203 and has an effective focal length of EFL_G1. In preferred embodiment, the EFL_G1 should be equal or greater than 2 times the EFL of the whole lens in order to achieve maximum thermal stability. An aperture stop 2209 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2204, positive powered lens element L5 2205 and negative powered lens element L6 2206. L5 and L6 function together as an air spaced doublet. Group 2 has an effective focal length of EFL_G2. The image surface 2208 of the last element nearest the light source 2207 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 22 shows the optical prescription of Example 22.

TABLE 22A

| Surface | Surface | | | | | Clear | |
|---|---|---|---|---|---|---|---|
| ID | Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 3.96E+01 | 9.95E+00 | 1.620, 60.374 | 2.43E+01 | 0.00E+00 |
| 2 | STANDARD | | Infinity | 7.45E+00 | | 2.37E+01 | 0.00E+00 |
| 3 | STANDARD | L2 | −4.27E+01 | 3.19E+00 | 1.585, 29.909 | 2.35E+01 | 0.00E+00 |
| 4 | EVENASPH | | 4.20E+02 | 1.84E+01 | | 2.28E+01 | 0.00E+00 |
| 5 | STANDARD | L3 | 3.24E+01 | 9.68E+00 | 1.620, 60.374 | 2.08E+01 | 0.00E+00 |
| 6 | STANDARD | | −3.47E+02 | 9.94E−02 | | 2.08E+01 | 0.00E+00 |
| 7 | EVENASPH | L4(stop) | 2.83E+01 | 6.79E+00 | 1.492, 57.949 | 1.61E+01 | −1.41E+00 |
| 8 | EVENASPH | | −3.46E+02 | 1.01E−01 | | 1.52E+01 | 0.00E+00 |
| 9 | STANDARD | L5 | 2.15E+01 | 6.82E+00 | 1.773, 49.613 | 1.31E+01 | 0.00E+00 |
| 10 | STANDARD | L6 | −101. | 2.54E+00 | 1.847, 23.787 | 1.31E+01 | 0.00E+00 |
| 11 | STANDARD | | 1.44E+01 | 6.95E+00 | | 8.47E+00 | 0.00E+00 |
| 12 | STANDARD | | Infinity | 0.00E+00 | | 6.47E+00 | 0.00E+00 |

TABLE 22B

| | EVENASPH | EVENASPH | EVENASPH |
|---|---|---|---|
| | for Image | for Object | for Image |
| | Surface | Surface | Surface |
| Coefficients | of L2 | of L4 | of L4 |
| r\hat{ }4 | 1.12E−06 | 8.03E−06 | 1.71E−05 |
| r\hat{ }6 | −5.35E−09 | 6.70E−09 | −1.62E−08 |
| r\hat{ }8 | 1.68E−12 | −2.18E−11 | 2.29E−11 |

Parametric expressions (11)-(20) are satisfied:

| Parameter | Value |
|---|---|
| EFL | 30.80 |
| F-number | 0.67 |
| EFL_G1/EFL | 1.78 |
| EFL_L1/EFL | 2.09 |
| EFL_L2/EFL | −2.15 |
| EFL_L3/EFL | 1.58 |
| EFL_G2/EFL | 2.58 |
| EFL_L4/EFL | 1.75 |
| EFL_L5/EFL | 0.93 |
| EFL_L6/EFL | −0.55 |
| RL/EFL | 0.47 |
| TTL/Ah | 5.62 |
| EFL/Ah | 2.41 |
| R11/TTL | 0.20 |

### Example 23

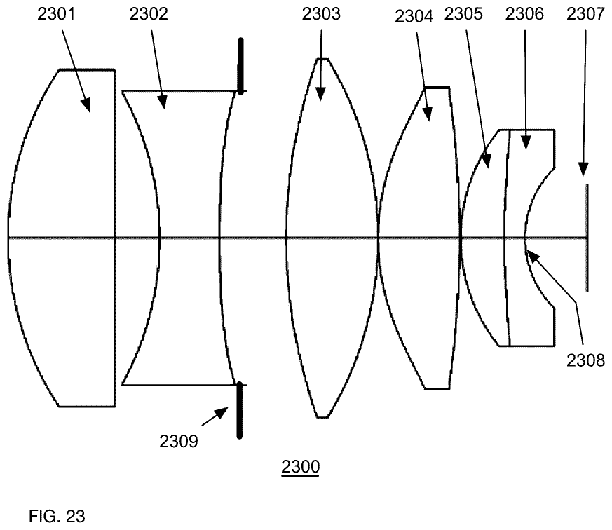

FIG. 23 shows the layout of Example 23. This design has a field angle of +/−12° with a relative aperture of F/0.75 and an effective focal length EFL of 30.5 when used with a 12.8 mm (Ah) image source. The embodiment of an imaging projection lens system 2300 shows an imaging lighting lens of a low F/#which has good optical efficiency and is high resolution.

It comprises two positive powered lens groups. Group 1 comprises L1 2301, L2 2302 and L3 2303 and has an effective focal length of EFL_G1. In preferred embodiment, the EFL_G1 should be equal or greater than 2 times the EFL of the whole lens in order to achieve maximum thermal stability. An aperture stop 2309 is located in group 1 at the image surface of L2. The optical powers of the lens elements in the first group are positive, negative, positive respectively. Group 2 has positive power and comprises positive powered lens element L4 2304, positive powered lens element L5 2305 and negative powered lens element L6 2306. L5 and L6 function together as an air spaced doublet. Group 2 has an effective focal length of EFL_G2. The image surface 2308 of the last element nearest the light source 2307 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R12|. Table 23 shows the optical prescription of Example 23.

TABLE 23A

| Surface | Surface | | | | | Clear | |
|---|---|---|---|---|---|---|---|
| ID | Type | lens | Radius | Thickness | Material | Semi | Conic |
| 0 | STANDARD | | Infinity | 1.00E+04 | | 2.13E+03 | 0.00E+00 |
| 1 | STANDARD | L1 | 3.76E+01 | 1.32E+01 | 1.620, 60.374 | 2.09E+01 | 0.00E+00 |
| 2 | STANDARD | | Infinity | 5.62E+00 | | 1.87E+01 | 0.00E+00 |
| 3 | STANDARD | L2 | −3.75E+01 | 7.43E+00 | 1.585, 29.909 | 1.82E+01 | 0.00E+00 |
| 4 | EVENASPH | | 1.34E+02 | 2.37E+00 | | 1.82E+01 | 0.00E+00 |
| 5 | STANDARD | stop | Infinity | 5.95E+00 | | 1.83E+01 | 0.00E+00 |
| 6 | STANDARD | L3 | 6.68E+01 | 1.14E+01 | 1.620, 60.374 | 2.22E+01 | 0.00E+00 |
| 7 | STANDARD | | −4.25E+01 | 0.00E+00 | | 2.23E+01 | 0.00E+00 |
| 8 | EVENASPH | L4 | 2.78E+01 | 1.02E+01 | 1.492, 57.949 | 1.87E+01 | −2.11E+00 |
| 9 | EVENASPH | | −9.18E+01 | 1.01E−01 | | 1.76E+01 | 0.00E+00 |
| 10 | STANDARD | L5 | 2.12E+01 | 5.47E+00 | 1.773, 49.613 | 1.35E+01 | 0.00E+00 |
| 11 | STANDARD | L6 | 1.34E+02 | 2.54E+00 | 1.847, 23.787 | 1.35E+01 | 0.00E+00 |
| 12 | STANDARD | | 1.22E+01 | 7.74E+00 | | 8.67E+00 | 0.00E+00 |
| 13 | STANDARD | | Infinity | 0.00E+00 | | 6.65E+00 | 0.00E+00 |

TABLE 23B

| | EVENASPH | EVENASPH | EVENASPH |
|---|---|---|---|
| | for Image | for Object | for Image |
| | Surface | Surface | Surface |
| Coefficients | of L2 | of L4 | of L4 |
| r\hat{ }4 | 6.31E−06 | 8.19E−06 | 1.33E−05 |
| r\hat{ }6 | −1.81E−09 | −7.66E−09 | −3.95E−08 |
| r\hat{ }8 | 7.84E−12 | −3.41E−11 | 4.03E−11 |

Parametric expressions (11)-(20) are satisfied:

| Parameter | Value |
|---|---|
| EFL | 30.50 |
| F-number | 0.75 |
| EFL_G1/EFL | 1.82 |
| EFL_L1/EFL | 1.98 |
| EFL_L2/EFL | −1.61 |
| EFL_L3/EFL | 1.43 |
| EFL_G2/EFL | 3.06 |
| EFL_L4/EFL | 1.46 |
| EFL_L5/EFL | 0.88 |
| EFL_L6/EFL | −0.47 |
| RL/EFL | 0.40 |
| TTL/Ah | 5.63 |
| EFL/Ah | 2.38 |
| R12/TTL | 0.17 |

### Example 24

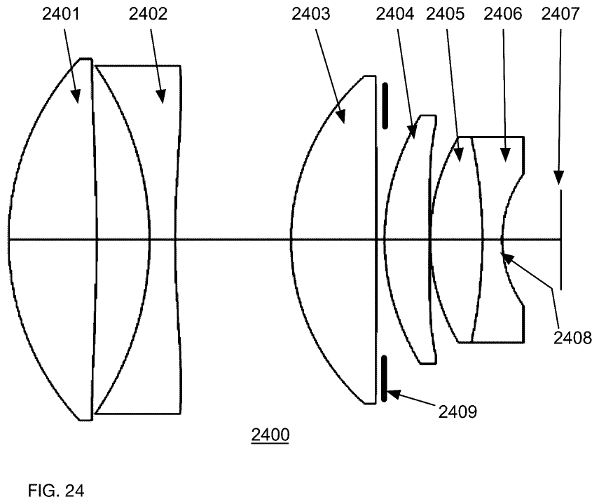

FIG. 24 shows the layout of Example 24. This design has a field angle of +/−12° with a relative aperture of F/0.7 and an effective focal length EFL of 30.8 when used with a 12.8 mm (Ah) image source. The embodiment of an imaging projection lens system 2400 shows an imaging lighting lens of a low F/#which has good optical efficiency and is high resolution.

It comprises two positive powered lens groups. Group 1 comprises L1 2401, L2 2402 and L3 2403 and has an effective focal length of EFL_G1. In preferred embodiment, the EFL_G1 should be equal or greater than 2 times the EFL of the whole lens in order to achieve maximum thermal stability. An aperture stop 2409 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2404, positive powered lens element L5 2405 and negative powered lens element L6 2406. L5 and L6 function together as an air spaced doublet. Group 2 has an effective focal length of EFL_G2. The image surface 2408 of the last element nearest the light source 2407 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 24 shows the optical prescription of Example 24.

TABLE 24A

| Surface | Surface | | | | | Clear | |
|---|---|---|---|---|---|---|---|
| ID | Type | lens | Radius | Thickness | Material | Semi | Conic |
| 0 | STANDARD | | Infinity | 1.00E+04 | | 2.14E+03 | 0.00E+00 |
| 1 | STANDARD | L1 | 3.45E+01 | 1.15E+01 | 1.492, 57.441 | 2.35E+01 | 0.00E+00 |
| 2 | EVENASPH | | −2.12E+02 | 6.90E+00 | | 2.29E+01 | 0.00E+00 |
| 3 | STANDARD | L2 | −3.97E+01 | 3.36E+00 | 1.585, 29.909 | 2.26E+01 | 0.00E+00 |
| 4 | EVENASPH | | 1.34E+02 | 1.51E+01 | | 2.26E+01 | 0.00E+00 |
| 5 | STANDARD | L3 | 2.85E+01 | 1.11E+01 | 1.620, 60.374 | 2.13E+01 | 0.00E+00 |
| 6 | STANDARD | | −2.35E+03 | 1.07E+00 | | 2.07E+01 | 0.00E+00 |
| 7 | EVENASPH | L4 (stop) | 2.95E+01 | 5.85E+00 | 1.694, 53.151 | 1.61E+01 | −4.96E−01 |
| 8 | EVENASPH | | −8.58E+02 | 1.02E−01 | | 1.51E+01 | 0.00E+00 |
| 9 | STANDARD | L5 | 2.61E+01 | 6.80E+00 | 1.773, 49.613 | 1.33E+01 | 0.00E+00 |
| 10 | STANDARD | L6 | −6.21E+01 | 2.58E+00 | 1.847, 23.787 | 1.33E+01 | 0.00E+00 |
| 11 | STANDARD | | 1.46E+01 | 7.62E+00 | | 8.56E+00 | 0.00E+00 |
| 12 | STANDARD | | Infinity | 0.00E+00 | | 6.52E+00 | 0.00E+00 |

TABLE 24B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 2.53E−06 | −2.54E−06 | 4.97E−06 | 2.42E−05 |
| r\hat{ }6 | −3.98E−10 | −7.01E−09 | −2.53E−08 | −5.51E−08 |
| r\hat{ }8 | | 4.63E−12 | 4.04E−11 | 1.40E−10 |

Parametric expressions (11)-(20) are satisfied:

| Parameter | Value |
|---|---|
| EFL | 30.80 |
| F-number | 0.70 |
| EFL_G1/EFL | 1.81 |
| EFL_L1/EFL | 1.98 |
| EFL_L2/EFL | −1.67 |
| EFL_L3/EFL | 1.47 |
| EFL_G2/EFL | 2.55 |
| EFL_L4/EFL | 1.33 |
| EFL_L5/EFL | 1.13 |
| EFL_L6/EFL | −0.54 |
| RL/EFL | 0.47 |
| TTL/Ah | 5.62 |
| EFL/Ah | 2.41 |
| R11/TTL | 0.20 |

### Example 25

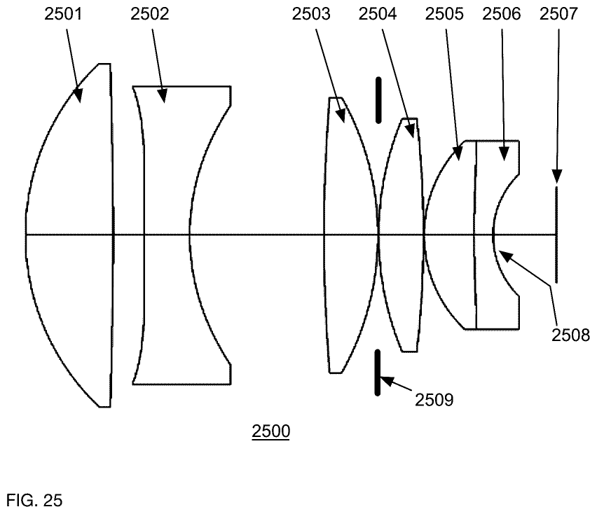

FIG. 25 shows the layout of Example 25. This design has a field angle of +/−12° with a relative aperture of F/0.76 and an effective focal length EFL of 33.3 when used with a 12.8 mm (Ah) image source. The embodiment of an imaging projection lens system 2500 shows an imaging lighting lens of a low F/#which has good optical efficiency and is high resolution.

It comprises two positive powered lens groups. Group 1 comprises L1 2501, L2 2502 and L3 2503 and has an effective focal length of EFL_G1. In preferred embodiment, the EFL_G1 should be equal or greater than 2 times the EFL of the whole lens in order to achieve maximum thermal stability. An aperture stop 2509 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2504, positive powered lens element L5 2505 and negative powered lens element L6 2506. L5 and L6 function together as an air spaced doublet. Group 2 has an effective focal length of EFL_G2. The image surface 2508 of the last element nearest the light source 2507 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 25 shows the optical prescription of Example 25.

TABLE 25A

| Surface | Surface | | | | | Clear | |
|---|---|---|---|---|---|---|---|
| ID | Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 34.7 | 1.29E+01 | 1.492, 57.441 | 2.51E+01 | 0.00E+00 |
| 2 | EVENASPH | | −316 | 4.50E+00 | | 2.43E+01 | 0.00E+00 |
| 3 | EVENASPH | L2 | 475 | 6.70E+00 | 1.585, 29.909 | 2.19E+01 | 0.00E+00 |
| 4 | EVENASPH | | 32.2 | 1.97E+01 | | 1.89E+01 | 0.00E+00 |
| 5 | STANDARD | L3 | 246 | 7.90E+00 | 1.620, 60.374 | 2.01E+01 | 0.00E+00 |
| 6 | STANDARD | | −40.9 | 1.08E−01 | | 2.02E+01 | 0.00E+00 |
| 7 | STANDARD | L4 (stop) | 44.0 | 6.56E+00 | 1.620, 60.374 | 1.71E+01 | 0.00E+00 |
| 8 | STANDARD | | −149 | 1.08E−01 | | 1.65E+01 | 0.00E+00 |
| 9 | STANDARD | L5 | 18.9 | 7.36E+00 | 1.773, 49.613 | 1.38E+01 | 0.00E+00 |
| 10 | STANDARD | L6 | 267 | 2.75E+00 | 1.847, 23.787 | 1.27E+01 | 0.00E+00 |
| 11 | STANDARD | | 12.4 | 9.29E+00 | | 8.90E+00 | 0.00E+00 |
| 12 | STANDARD | | Infinity | 0.00E+00 | | 7.02E+00 | 0.00E+00 |

TABLE 25B

| | EVENASPH | EVENASPH | EVENASPH |
|---|---|---|---|
| | for Image | for Object | for Image |
| | Surface | Surface | Surface |
| Coefficients | of L1 | of L2 | of L2 |
| r\hat{ }4 | 2.85E−06 | −8.05E−06 | −2.00E−06 |
| r\hat{ }6 | −2.17E−09 | −3.61E−09 | 8.82E−09 |
| r\hat{ }8 | | | −2.41E−11 |

Parametric expressions (11)-(20) are satisfied:

| Parameter | Value |
|---|---|
| EFL | 33.30 |
| F-number | 0.76 |
| EFL_G1/EFL | 2.03 |
| EFL_L1/EFL | 1.92 |
| EFL_L2/EFL | −1.77 |
| EFL_L3/EFL | 1.71 |
| EFL_G2/EFL | 2.12 |
| EFL_L4/EFL | 1.66 |
| EFL_L5/EFL | 0.73 |
| EFL_L6/EFL | −0.44 |
| RL/EFL | 0.37 |
| TTL/Ah | 6.08 |
| EFL/Ah | 2.60 |
| R11/TTL | 0.16 |

### Example 26

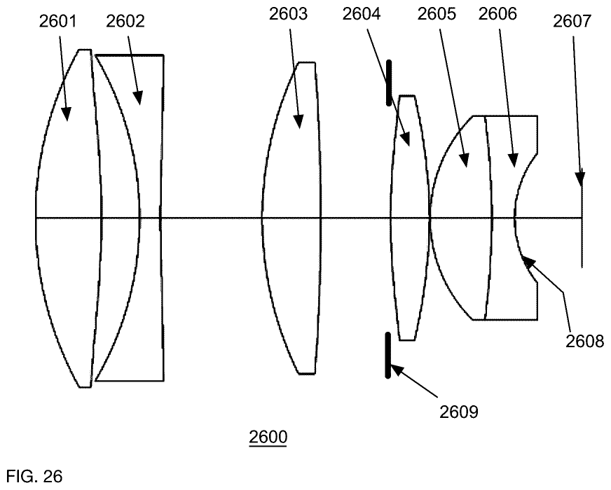

FIG. 26 shows the layout of Example 26. This design has a field angle of +/−12° with a relative aperture of F/0.79 and an effective focal length EFL of 30.8 when used with a 12.8 mm (Ah) image source. The embodiment of an imaging projection lens system 2600 shows an imaging lighting lens of a low F/#which has good optical efficiency and is high resolution.

It comprises two positive powered lens groups. Group 1 comprises L1 2601, L2 2602 and L3 2603 and has an effective focal length of EFL_G1. In preferred embodiment, the EFL_G1 should be equal or greater than 2 times the EFL of the whole lens in order to achieve maximum thermal stability. An aperture stop 2609 is located in group 1 at the image surface of L3. The stop location is closer to the light source to help with field aberration correction. The optical powers of the lens elements in the first group are positive, negative, positive respectively. Group 2 has positive power and comprises positive powered lens element L4 2604, positive powered lens element L5 2605 and negative powered lens element L6 2606. L5 and L6 function together as an air spaced doublet. Group 2 has an effective focal length of EFL_G2. The image surface 2608 of the last element nearest the light source 2607 has a radius of RL. All lens elements are spherical except for L2 and L4. The radius of curvature of individual lens shape is chosen to lower fabrication cost, stray light generation and aberration contribution. The absolute value of the radius of curvature of the lens surface |Ri| with the smallest radius of curvature is |R11|. Table 26 shows the optical prescription of Example 26.

TABLE 26A

| Surface | Surface | | | | | Clear | |
|---|---|---|---|---|---|---|---|
| ID | Type | LENS | Radius | Thickness | Material | Semi | Conic |
| 0 | STANDARD | | Infinity | 1.00E+04 | | 2.14E+03 | 0.00E+00 |
| 1 | STANDARD | L1 | 46.0 | 8.71E+00 | 1.492, 57.441 | 2.23E+01 | 0.00E+00 |
| 2 | EVENASPH | | −104 | 5.03E+00 | | 2.18E+01 | 0.00E+00 |
| 3 | STANDARD | L2 | −42.2 | 2.76E+00 | 1.585, 29.909 | 2.15E+01 | 0.00E+00 |
| 4 | EVENASPH | | 233 | 1.34E+01 | | 2.11E+01 | 0.00E+00 |
| 5 | STANDARD | L3 | 46.5 | 7.67E+00 | 1.620, 60.374 | 2.05E+01 | 0.00E+00 |
| 6 | STANDARD | | −271 | 9.22E+00 | | 2.05E+01 | 0.00E+00 |
| 7 | EVENASPH | L4 (stop) | 94.1 | 5.11E+00 | 1.694, 53.151 | 1.61E+01 | 2.23E+01 |
| 8 | EVENASPH | | −59.6 | 9.95E−02 | | 1.60E+01 | 0.00E+00 |
| 9 | STANDARD | L5 | 18.9 | 8.12E+00 | 1.773, 49.613 | 1.34E+01 | 0.00E+00 |
| 10 | STANDARD | L6 | −99.5 | 3.03E+00 | 1.847, 23.787 | 1.34E+01 | 0.00E+00 |
| 11 | STANDARD | | 13.8 | 8.83E+00 | | 8.63E+00 | 0.00E+00 |
| 12 | STANDARD | | Infinity | 0.00E+00 | | 6.54E+00 | 0.00E+00 |

TABLE 26B

| | EVENASPH | EVENASPH | EVENASPH | EVENASPH |
|---|---|---|---|---|
| | for Image | for Image | for Object | for Image |
| | Surface | Surface | Surface | Surface |
| Coefficients | of L1 | of L2 | of L4 | of L4 |
| r\hat{ }4 | 5.01E−06 | −4.44E−06 | −1.43E−06 | 1.04E−05 |
| r\hat{ }6 | −1.86E−09 | 1.67E−09 | −3.34E−08 | −4.63E−08 |
| r\hat{ }8 | | 4.30E−12 | 2.10E−11 | 7.96E−11 |

Parametric expressions (11)-(20) are satisfied:

| Parameter | Value |
|---|---|
| EFL | 30.8 |
| F-number | 0.79 |
| EFL_G1/EFL | 2.31 |
| EFL_L1/EFL | 2.14 |
| EFL_L2/EFL | −1.96 |
| EFL_L3/EFL | 2.09 |
| EFL_G2/EFL | 1.59 |
| EFL_L4/EFL | 1.72 |
| EFL_L5/EFL | 0.80 |
| EFL_L6/EFL | −0.52 |
| RL/EFL | 0.45 |
| TTL/Ah | 5.62 |
| EFL/Ah | 2.41 |
| R11/TTL | 0.19 |

### Example 27

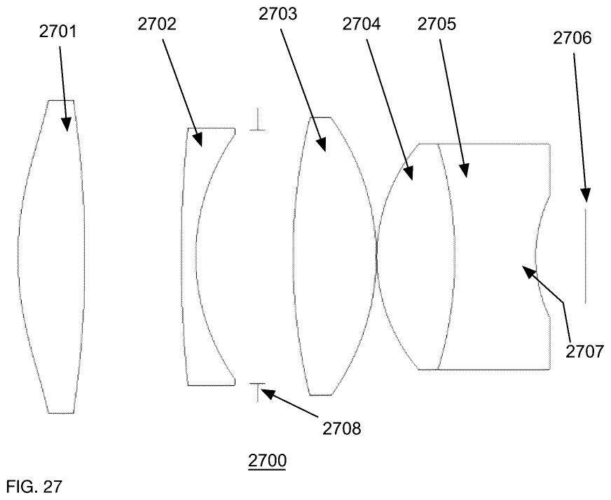

FIG. 27 shows the layout of a five lens element embodiment of an imaging lens system 2700. This design has a field angle of +/−12° with a relative aperture of F/0.76 and an effective focal length of 33.4. This example of present invention shows an imaging lighting lens of a low F/#which has good optical efficiency and is high resolution.

It comprises two positive powered lens groups. Group 1 comprises L1 2701, L2 2702 and L3 2703 and has an effective focal length of EFL_G1. An aperture stop 2708 is located in group 1 between L2 and L3. The optical powers of the lens elements in the first group are positive, negative, positive respectively. L1 is made of molded glass to achieve good aberration correction and thermal performance stability. Group 2 in this example has positive power and comprises positive powered lens element L4 2704 and negative powered lens element L5 2705. L4 and L5 form a cemented or air gap doublet. The cemented surface in group 2 is helpful in the reduction of blue fringes and improve efficiency. Group 2 has an effective focal length of EFL_G2. The image surface 2707 of the last element nearest the light source 2706 has a radius of RL. All lens elements are made of glass material in order to achieve maximum thermal stability. The radius of curvature of individual lens shape is chosen to lower fabrication cost, stray light generation and aberration contribution. The absolute value of the radius of curvature of the lens surface |Ri| with the smallest radius of curvature is |R10|. Table 27 shows the optical prescription of Example 27.

TABLE 27

| | | | | Glass | Clear | | |
|---|---|---|---|---|---|---|---|
| Surface | Type | Radius | Thickness | nd, abbe no. | Diam | Conic | LENS |
| OBJ | SPHERICAL | Infinity | 10000.00 | | | 0.00 | |
| 1 | ASPHERICAL | 48.3 | 9.2 | 1.52, 58 | 50 | −2.267 | L1 |
| 2 | ASPHERICAL | −155.8 | 13.3 | | 50 | | |
| 3 | SPHERICAL | 197.1 | 2 | 1.67, 32 | 38 | | L2 |
| 4 | SPHERICAL | 32.5 | 8.5 | | 38 | | |
| STO | SPHERICAL | Infinity | 4.9 | | 37 | | |
| 6 | SPHERICAL | 90.5 | 11.4 | 1.62, 60 | 40 | | L3 |
| 7 | SPHERICAL | −36.6 | 0.1 | | 40 | | |
| 8 | SPHERICAL | 26.6 | 10.7 | 1.80, 47 | 32 | | L4 |
| 9 | SPHERICAL | −59.9 | 11.1 | 1.81, 25 | 31 | | L5 |
| 10 | SPHERICAL | 21.7 | 6.96 | | | | |
| IMA | SPHERICAL | Infinity | | | 14 | 0.00 | |

The image surface of L2 and both the image and the object surfaces of L3 are aspherical with the following aspheric formula parameters for the equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} .$$

### Object Surface of L1

| | |
|---|---|
| Coefficient on r² | 0 |
| Coefficient on r⁴ | 0 |
| Coefficient on r⁶ | −7.414e−9 |
| Coefficient on r⁸ | 2.064e−12 |

### Image Surface of L1

| | |
|---|---|
| Coefficient on r² | 0 |
| Coefficient on r⁴ | 2.169e−6 |
| Coefficient on r⁶ | −7.489e−9 |
| Coefficient on r⁸ | 8.099e−12 |

The parametric equations (11)-(20) are satisfied:

| Parameter | Value |
|---|---|
| EFL | 33.4 |
| F-number | 0.76 |
| EFL_G1/EFL | 1.7 |
| EFL_L1/EFL | 2.14 |
| EFL_L2/EFL | −1.74 |
| EFL_L3/EFL | 1.30 |
| EFL_G2/EFL | 4.54 |
| EFL_L4/EFL | 0.99 |
| EFL_L5/EFL | −0.8 |
| RL/EFL | 0.65 |
| TTL/Ah | 6.11 |
| EFL/Ah | 2.61 |
| R10/TTL | 0.28 |

### SUMMARY

A lens system design for an imaging projection lens is described. The system enables selection of performance requirements of a high or low resolution lens system as described through a set of examples meeting a set of parametric equations. A low resolution imaging lenses has a field angle between 15 and 20 degrees and effective focal lengths (EFL) between 18 and 25. The high resolution lens systems have an EFL between 30 and 38 source and field angles between 10 and 12 degrees. The examples all use a 12.8 mm light source (Ah). The lens system is scaled to other size light sources using the parametric equation for EFL/Ah. The lens system comprises two positive powered lens groups. There are 3 lens elements in a first group and 1 to 3 lens element in a second group, the second group is nearest the light source.

We claim:

1. An imaging lighting lens system having an effective focal length (EFL), a total track length (TTL), and an f-number (F/#), used for projecting light from an array light source having a width (Ah) and located at an image plane, the lens system comprising two lens groups, each lens group comprised of lens elements each lens element having two radii of curvature (Ri) and the groups ordered from object to image:
a. group 1 has positive power and comprises three lens elements, L1, L2, L3 having optical powers that are positive, negative, positive respectively, and, includes an aperture stop, and, has an effective focal length (EFL_G1), and,
b. group 2 has positive power and comprises one, two, or, three lens element, has an effective focal length (EFL_G2), and, a lens surface, that is nearest the light source, has a radius (RL), and,
c. the f-number is less than 0.8, and,
d. the ratio of EFL to Ah is between 1.2 and 2.0 for lower resolution applications or between 2.2 and 3.0 for higher resolution applications.

2. The imaging lighting lens system of claim 1 wherein group 2 includes a single positive power lens element, L4.

3. The imaging lighting lens system of claim 1 wherein group 2 includes, from object to image, a positive power lens element, L4, and a negative power lens element, L5.

4. The imaging lighting lens system of claim 1 wherein group 2 includes, from object to image, a positive power lens element, L4, a positive power lens element, L5, and a negative power lens element, L6.

5. The imaging lighting lens system of claim 1 that satisfies the parametric equations:
$$a . 1.5 <= EFL\_G 1 / EFL <= 2. \qquad ( 1 )$$
$$b . 1. <= EFL\_G2 / EFL <= 1.6 \qquad ( 5 )$$
$$c . 1.5 <= RL / EFL \qquad ( 6 )$$
$$d . TTL / Ah < 5. \qquad ( 7 )$$
$$e . \vert Ri \vert / TTL > 0.23 \qquad ( 8 )$$
$$f . 1.2 <= EFL / Ah <= 2. \qquad ( 10 )$$

6. The imaging lighting lens system of claim 2 that satisfies the parametric equations:
$$a . 1.5 <= EFL\_G 1 / EFL <= 2. \qquad ( 1 )$$
$$b . 1. <= EFL\_G2 / EFL <= 1.6 \qquad ( 5 )$$
$$c . 1.5 <= RL / EFL \qquad ( 6 )$$
$$d . TTL / Ah < 5. \qquad ( 7 )$$
$$e . \vert Ri \vert / TTL > 0.23 \qquad ( 8 )$$
$$f . 1.2 <= EFL / Ah <= 2. \qquad ( 10 )$$

7. The imaging lighting lens system of claim 1 that satisfies the parametric equations:
$$a . 1.6 <= EFL\_G 1 / EFL <= 2.4 \qquad ( 11 )$$
$$b . 1. <= EFL\_G 1 / EFL <= 4.5 \qquad ( 15 )$$
$$c . 0.3 <= RL / EFL \qquad ( 16 )$$
$$d . TTL / Ah < 6. \qquad ( 17 )$$
$$e . \vert Ri \vert / TTL >= 0.16 \qquad ( 18 )$$
$$f . 2.2 <= EFL / Ah <= 3. \qquad ( 20 )$$

8. The imaging lighting lens system of claim 2 that satisfies the parametric equations:
$$a . 1.6 <= EFL\_G 1 / EFL <= 2.4 \qquad ( 11 )$$
$$b . 1. <= EFL\_G 1 / EFL <= 4.5 \qquad ( 15 )$$
$$c . 0.3 <= RL / EFL \qquad ( 16 )$$
$$d . TTL / Ah < 6. \qquad ( 17 )$$
$$e . \vert Ri \vert / TTL >= 0.16 \qquad ( 18 )$$
$$f . 2.2 <= EFL / Ah <= 3. \qquad ( 20 )$$

9. The imaging lighting lens system of claim 3 that satisfies the parametric equations:
$$a . 1.6 <= EFL\_G 1 / EFL <= 2.4 \qquad ( 11 )$$
$$b . 1. <= EFL\_G 1 / EFL <= 4.5 \qquad ( 15 )$$
$$c . 0.3 <= RL / EFL \qquad ( 16 )$$
$$d . TTL / Ah < 6. \qquad ( 17 )$$
$$e . \vert Ri \vert / TTL >= 0.16 \qquad ( 18 )$$
$$f . 2.2 <= EFL / Ah <= 3. \qquad ( 20 )$$

10. The imaging lighting lens system of claim 4 that satisfies the parametric equations:
$$a . 1.6 <= EFL\_G 1 / EFL <= 2.4 \qquad ( 11 )$$
$$b . 1. <= EFL\_G 1 / EFL <= 4.5 \qquad ( 15 )$$
$$c . 0.3 <= RL / EFL \qquad ( 16 )$$
$$d . TTL / Ah < 6. \qquad ( 17 )$$
$$e . \vert Ri \vert / TTL >= 0.16 \qquad ( 18 )$$
$$f . 2.2 <= EFL / Ah <= 3. \qquad ( 20 )$$

11. An imaging lighting lens system having an effective focal length (EFL), a total track length (TTL), and an f-number (F/#), used for projecting light from an array light source having a width (Ah) and located at an image plane, the lens system consisting of two lens groups each lens group consisting of lens elements each lens element having two radii of curvature (Ri) the lens groups ordered from object to image:
a. group 1 has positive power and consists of three lens elements, L1, L2, L3, having optical powers that are positive, negative, positive respectively, and, an aperture stop, and, has an effective focal length (EFL_G1), and,
b. group 2 has positive power and consists of one, two, or, three lens element, has an effective focal length (EFL_G2), and, a lens surface, that is nearest the light source, has a radius (RL), and,
c. the f-number is less than 0.8, and,
d. the ratio of EFL to Ah is between 1.2 and 2.0 for lower resolution applications or between 2.2 and 3.0 for higher resolution applications.

12. The imaging lighting lens system of claim 11 wherein group 2 consists of a single positive power lens element, L4.

13. The imaging lighting lens system of claim 11 wherein group 2 consists of, from object to image, a positive power lens element, L4, and a negative power lens element, L5.

14. The imaging lighting lens system of claim 11 wherein group 2 consists of, from object to image, a positive power lens element, L4, a positive power lens element, L5, and a negative power lens element, L6.

15. The imaging lighting system of claim 12 wherein the ratio of EFL to Ah is between 1.2 and 2.0, all lens element surfaces are spherical and all lens elements are made of glass.

16. The imaging lighting system of claim 12 wherein the ratio of EFL to Ah is between 2.2 and 3.0, all lens element surfaces are spherical and all lens elements are made of glass.

17. The imaging lighting system of claim 12 wherein the ratio of EFL to Ah is between 2.2 and 3.0.

18. The imaging lighting system of claim 13 wherein the ratio of EFL to Ah is between 2.2 and 3.0 and all lens elements are made of glass.
